(19) United States
(12) Patent Application Publication
(10) Pub. No.: US 2026/0092662 A1
(43) Pub. Date: Apr. 2, 2026

(54) SYSTEM AND METHOD FOR SUPPORTING RISERS FROM FLOATING VESSEL

(71) Applicant: National Coupling Company, Inc., Stafford, TX (US)

(72) Inventor: Russell Eric McBeth, The Woodlands, TX (US)

(21) Appl. No.: 19/413,265

(22) Filed: Dec. 9, 2025

Related U.S. Application Data
(63) Continuation-in-part of application No. 18/923,469, filed on Oct. 22, 2024, now Pat. No. 12,534,967.
(60) Provisional application No. 63/607,487, filed on Dec. 7, 2023.
(60) Provisional application No. 63/735,783, filed on Dec. 18, 2024.

(51) Int. Cl. F16L 37/23; B63B 27/24; E21B 17/01

(52) U.S. Cl. CPC F16L 37/23; B63B 27/24; E21B 17/01

(57) ABSTRACT

A system facilitates communication between a vessel and a subsea environment using a tubular component. The system includes a receiver and a connector. The receiver, mounted on the vessel, features a bore with an engagement shoulder and latch profile. The connector, attached to the tubular component, consists of a latch mechanism, trigger mechanism, wedge mechanism, and lock mechanism. The latch can move from a retracted to an extended position, allowing it to engage with the latch profile in the receiver's bore. The trigger, connected to the latch, activates when it contacts the engagement shoulder, moving the latch into its extended position. The wedge, coupled to the latch, wedges against the bore when the latch is extended. Finally, the lock mechanism secures the wedge in place by moving from an unlocked to a locked position, ensuring the wedge remains fixed against the bore of the receiver.

### CROSS-REFERENCE TO RELATED APPLICATIONS

This application claims the benefit of U.S. Provisional Appl. No. 63/735,783 filed Dec. 18, 2024 and is a continuation-in-part of U.S. Non-Provisional application Ser. No. 18/923,469 filed Oct. 22, 2024, which claims the benefit of U.S. Provisional Appl. No. 63/607,487 filed Dec. 7, 2023, each of which is incorporated herein by reference in its entirety.

### BACKGROUND OF THE DISCLOSURE

Risers and riser support systems have been used on structures and vessels, such as floating production storage and offloading (FPSO) units. For example, U.S. Pat. No. 5,947,642 discloses an apparatus for connecting an underwater flexible riser to a structure on the surface. US 2007/0056741 discloses an apparatus for supporting a steel catenary riser from a floating structure. WO 2017/034409 discloses a top locking system for a riser tube on a floating vessel. WO 2019/232605 discloses a system for coupling between a bend stiffener and a bell mouth. Some systems have used an arrangement of double balconies. Some examples of these arrangements are disclosed in WO 2021/048592 and WO 2023/028680.

Some existing systems have complicated arrangements, cannot be operated without divers, or require hydraulic or other forms of actuation that may be subject to failure. Although existing systems may be effective, operators are always seeking ways to improve and simplify the structures and operations involved in supporting risers and other tubular components from a floating vessel. To that end, the subject matter of the present disclosure is directed to overcoming, or at least reducing the effects of, one or more of problems associated with existing systems.

### SUMMARY OF THE DISCLOSURE

In one configuration, a system supports a tubular component used to communicate between a vessel and a subsea environment. The system comprises a connector disposed on the tubular component. The connector is insertable in a receiver bore. The connector has a trigger and an anchor. The trigger is disposed on the connector and is mechanically triggered in response to engagement with the receiver bore. The trigger is configured to initiate a first mechanical movement. The anchor is disposed on the connector and is configured to mechanically engage against the receiver bore in response to the first mechanical movement.

In another configuration, a system supports a tubular component (e.g., rigid riser) used to communicate between a vessel and a subsea environment. The system comprises a receiver, a connector, and a support. The receiver is supported on the vessel and defines a receiver bore therethrough. The receiver has one or more pins movable relative to the receiver bore.

The connector is insertable in the receiver bore and has a trigger and an anchor. The trigger, which is disposed on the connector, is mechanically triggered in response to engagement with the receiver bore and is configured to initiate a first mechanical movement. The anchor is disposed on the connector and is configured to mechanically engage against the receiver bore in response to the first mechanical movement. A shoulder disposed on an exterior surface of the connector is configured to engage against the one or more pins movable relative to the receiver bore.

The support is connected to the rigid riser. The support has an upper stress joint and a lower stress joint. The upper stress joint is connected to an upper portion of the rigid riser, and the lower stress joint is connected to a lower portion of the rigid riser. The lower stress joint is disposed in the connector and extends from a lower end of the connector. Meanwhile, the upper stress joint is connected by a coupling to the lower stress joint and extends from a lower end of the connector. The coupling permits the upper stress joint to articulate relative to the lower stress joint.

In yet another configuration, a system supports a tubular component (e.g., a rigid riser) used to communicate between a vessel and a subsea environment. The system comprises a receiver, a connector, and a stress joint. The receiver is configured to be supported on the vessel. The receiver defines a receiver bore therethrough and has a hang-off interface. The connector is insertable in the receiver bore and has a trigger, an anchor, and a flange interface. The trigger is disposed on the connector. The trigger is mechanically triggered in response to engagement with the receiver bore and is configured to initiate a first mechanical movement. The anchor, which is disposed on the connector, is configured to mechanically engage against the receiver bore in response to the first mechanical movement. The flange interface is connected to an upper end of the connector and is configured to connect to the hang-off interface. Finally, the stress joint is connected to the rigid riser and is connected to a lower end of the connector.

A method disclosed herein is used for a vessel. The method comprises: inserting a connector disposed on a tubular component into a receiver bore of a receiver supported on the vessel; mechanically triggering a trigger disposed on the connector in response to engagement of the trigger in the receiver bore; mechanically releasing an anchor disposed on the connector in response to the mechanical triggering of the trigger; and mechanically anchoring the anchor against the receiver bore in response to the mechanical release.

In another configurations, a method used for a vessel comprises: connecting a support to a tubular component, such as a rigid riser, the support having an upper stress joint and a lower stress joint, the upper stress joint connected by a coupling to the lower stress joint; positioning the lower support in a connector; passing at least the upper stress joint through a receiver bore of a receiver supported on the vessel; permitting the upper stress joint to articulate relative to the lower stress joint in the connector; inserting the connector into the receiver bore; mechanically triggering a trigger disposed on the connector in response to engagement of the trigger in the receiver bore; mechanically releasing an anchor disposed on the connector in response to the mechanical triggering of the trigger; mechanically anchoring the anchor against the receiver bore in response to the mechanical release; and engaging one or more pins movable relative to the receiver bore against the connector (e.g., against a shoulder disposed on an exterior surface of the connector).

In yet another configuration, a method used for a vessel comprises: connecting a stress joint to a tubular component (e.g., a rigid riser); connecting the stress joint to a connector; inserting the connector into the receiver bore; mechanically triggering a trigger disposed on the connector in response to engagement of the trigger in the receiver bore; mechanically releasing an anchor disposed on the connector in response to the mechanical triggering of the trigger; mechanically anchoring the anchor against the receiver bore in response to the mechanical release; and mechanically connecting a flange interface on a top of the connector to a hang-off interface at the receptacle.

The foregoing summary is not intended to summarize each potential embodiment or every aspect of the present disclosure.

### BRIEF DESCRIPTION OF THE DRAWINGS

FIG. 1A illustrates a vessel having upper and lowers balconies with support systems for supporting risers.

FIG. 1B illustrates an end view of a side of the vessel having upper and lowers balconies with support systems.

FIG. 2 illustrates a cross-section of a support system, including a receiver with a connector positioned therein.

FIG. 3 illustrates an elevational view of the connector.

FIG. 4 illustrates a cross-section of a receiver for the support system for use with the connector.

FIG. 5A illustrates a detailed cross-section of a latch of the connector.

FIG. 5B illustrates a detailed cross-section of a trigger of the connector.

FIG. 5C illustrates a detailed cross-section of an anchor of the connector.

FIG. 6A illustrates a detailed cross-section of a lock of the connector.

FIG. 6B illustrates a detailed end-section of the lock of the connector.

FIG. 7A illustrates a cross-section of the receiver receiving the connector.

FIG. 7B illustrates a cross-section of the receiver during initial latching of the connector.

FIG. 7C illustrates a cross-section of the receiver during final latching of the connector.

FIG. 7D illustrates a cross-section of the receiver during disconnection of the connector.

FIG. 8A illustrates a cross-section of a support system, including a receiver having a connector supporting an umbilical or flexible pipe.

FIG. 8B illustrates a cross-section of a support system, including a receiver having a connector supporting a power cable.

FIG. 8C illustrates a cross-section of a support system, including a receiver having a connector supporting a rigid riser stress joint.

FIG. 9A illustrates a cross-section of another connector for a support system according to the present disclosure.

FIG. 9B illustrates a detailed cross-section of a portion of the connector in FIG. 9A.

FIG. 10A illustrates a cross-section of the receiver during initial latching of the connector.

FIG. 10B illustrates a cross-section of the receiver during final latching of the connector.

FIG. 10C illustrates a detailed cross-section of the receiver during disconnection of the connector.

FIG. 11 illustrates an end view of a side of a vessel having upper and lowers balconies and having a support system according to the present disclosure.

FIG. 12 illustrates a cross-sectional view of the support system of FIG. 11 at the upper and lower balconies of the vessel.

FIGS. 13A-13B illustrates a perspective view and a cross-sectional view of a receptacle for the support system of FIGS. 11 and 12B.

FIG. 14 illustrates a detailed cross-sectional view of a connector mounted in the receptacle for the support system of FIGS. 11 and 12B.

FIG. 15 illustrates a cross-sectional view of another configuration of the support system of FIG. 11 at the upper and lower balconies of the vessel.

FIG. 16 illustrates an end view of a side of a vessel having upper and lowers balconies and having another support system according to the present disclosure.

FIG. 17 illustrates a cross-sectional view of the support system of FIG. 16 at the upper and lower balconies of the vessel.

FIG. 18 illustrates a cross-sectional view of another configuration of the support system of FIG. 16 at the upper and lower balconies of the vessel.

### DETAILED DESCRIPTION OF THE DISCLOSURE

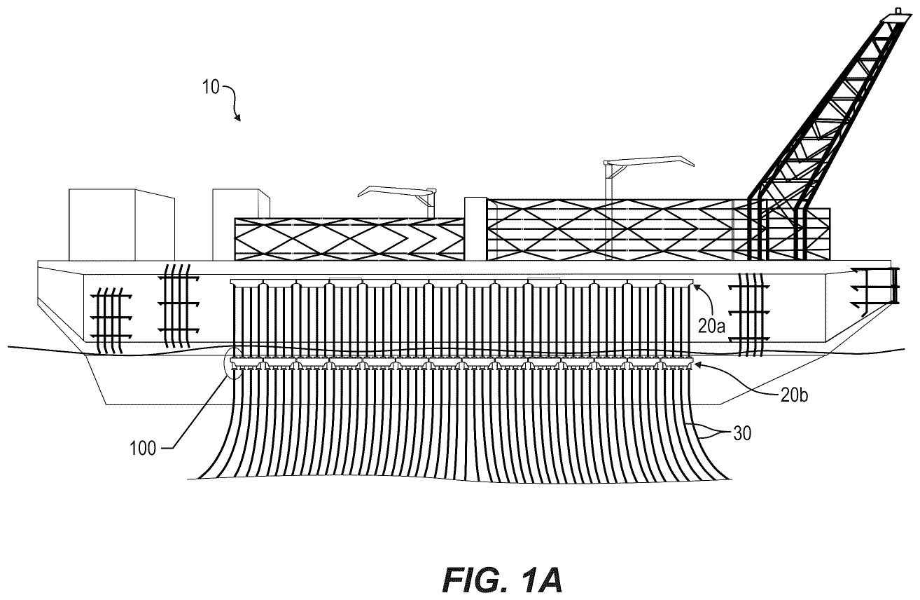

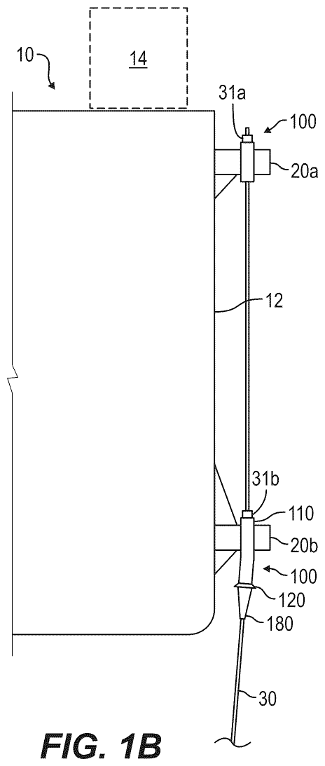

FIG. 1A illustrates a vessel 10 having upper and lowers platforms or balconies 20a-b for supporting tubular components 30, which extend subsea from the vessel 10. FIG. 1B illustrates a side 12 of the vessel 10 having the upper and lowers balconies 20a-b for supporting the tubular components 30.

As shown, the vessel 10 can be a floating production storage and offloading (FPSO) unit. The features of the present disclosure can be used with other types of structures and vessels. In general, the vessel 10 can include components for mobile offshore production and storage, and hydrocarbons produced from seabed wells can be transported to the vessel 10 using the tubular components 30, which can be flowlines or risers. (Tubular component, flowline, and riser may be used interchangeably herein.) Production facilities on the vessel 10 can then process the hydrocarbons by separating oil, gas, water, and impurities for storage in the hull of the vessel 10.

The tubular components 30 are used for communicating between the vessel 10 and components in a subsea environment. For example, the tubular components 30 can be flowlines, which can be flexible or rigid. In other examples, the tubular components 30 can be risers, which can be vertical transportation lines from the seabed to topside and which can be flexible or rigid. Other types of tubular components 30 can be used, such as umbilicals or power cables. In general, the tubular components 30 can conduct well fluids, injection fluids, etc. The tubular components 30 can also conduct electricity, electronic signals, hydraulics, and the like.

As shown, the upper and lower balconies 20a-b extend from the side 12 of the vessel 10 to support the tubular components 30. The lower balconies 20b may be situated below the minimum draft of the vessel 10, and the upper balconies 20a may be supported close to the deck level of the vessel. Support systems 100 are supported on the balconies 20a-b of the vessel 10 to hold the tubular components 30.

The lower balconies 20b and the support system 100 can support the tubular components 30 close to the vessel's keel level. In one arrangement, the receivers 110 on the lower balcony 20b can be vertically straight relative to the side 12 of the vessel 10. In an alternative arrangement, the receivers 110 can be angled or oriented away from vertical to disperse or spread the tubular components 30 as they extend below the vessel 10.

According to one arrangement of the present disclosure, the disclosed support system 100 can be used to support the tubular components 30 on one of the balconies 20a-b, while another support system is used on the other balcony 20a-b. According to another arrangement such as shown in FIG. 1B, the same support system 100 disclosed herein can be used to support the tubular components 30 on both of the balconies 20a-b depending on the implementation.

As best shown on the example lower balcony 20b in FIG. 1B, the support system 100 includes a receiver 110 and a connector 120. The receiver 110 is supported on one or both of the vessel's balconies 20a-b of the vessel 10 depending on how the associated tubular component 30 is to be supported on the vessel 10.

For example, the receiver 110 can be integrated into or affixed on either one or both of the balcony 20a-b of the vessel 10. The receiver 110 receives the connector 120, which is disposed on the tubular component 30.

Equipment 14 on the vessel 10 can be used with the tubular components 30. For example, the equipment 14 can include a top interface spool (not shown), which can be located at the deck of the vessel 10 above the upper receiver 110 and can connect to a termination 31a of the tubular component 30. The equipment 14 can include a pull-in platform (not shown), which can be located above the upper balcony 20a and can be used to pull in the tubular component 30 through one or both of the receivers 110 on the balconies 20a-b depending on how the tubular component 30 is to be supported. Using a pull-in operation, for example, the tubular component 30 can be pulled from the water to connect to the vessel 10 using the pull-in platform of the equipment 14. A pull-in wire can be connected by a pull-in head to a termination 31a of the tubular component 30, and the tubular component 30 can be passed through the receiver 110 on the lower balcony 20b until reaching the support system 100 on the upper balcony 20a.

The support system 100 on the lower balcony 20b provides an interface for the tubular component 30. As noted above, the support system 100 can be used for tubular components 30 that are either rigid or flexible. Accordingly, for a flexible tubular component 30, such as an umbilical, flexible pipe, rigid pipe, or power cable, the support system 100 on the lower balcony 20b can provide a hang-off interface for a bend limiter 180 to provide stiffening.

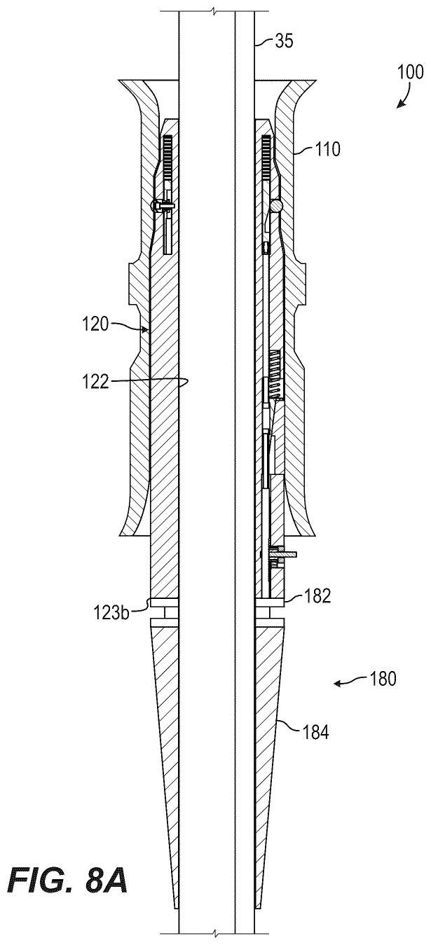

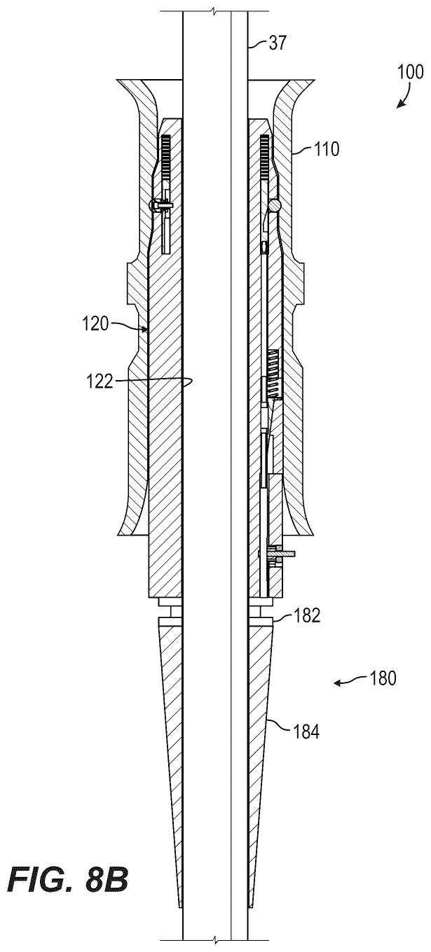

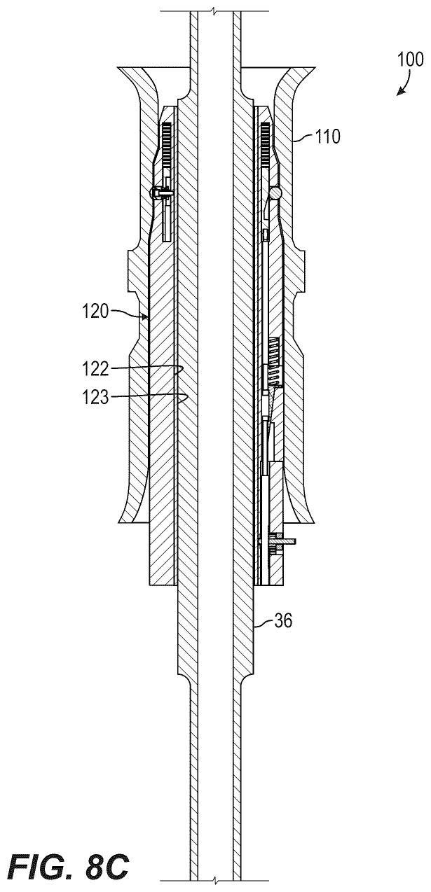

For a rigid tubular component 30 (e.g., rigid riser), the support system 100 on the lower balcony 20b can provide an interface for hang-off of a pipe support for a riser. For example, the connector 120 of the support system 100 can fill a gap between a bore of the receiver 110 and an outer diameter (OD) of a rigid pipe support (e.g., tubular 36 in FIG. 8C) after larger sections of a riser 30 have passed through the receiver 110. An internal wear sleeve (not shown) can line the inner diameter (ID) of the connector 120 to protect any coating on the rigid riser 30 as larger diameters of the rigid riser 30 pass through the connector 120. If desired, a flexible joint can be provided on the rigid riser 30 at the point below the lower balcony 20b to provide flexibility.

In one configuration of the support system 100, the weight of the tubular component 30 can be carried by the termination 31a at the level of the upper balcony 20a. In another configuration of the support system 100, the connector 120 at the lower balcony 20b can include additional latching features (e.g., balls or dogs) that increase the hang-off capacity to carry a complete weight (or at least a portion of the complete weight) of the tubular component 30 at the lower balcony 20b.

When the support system 100 is being used, the connector 120 on the tubular component 30 is engaged in the receiver 110 to complete traction support of the tubular component 30. At the lower balcony 20b, the connector 120 mechanically latches and anchors inside the receiver 110. Once latched and anchored, diverless operations can be performed to mechanically lock or rigidize the connector 120 in the receiver 110. For example, a remote operated vehicle (ROV) can be deployed below the water line to mechanically operate locking features on the connector 120 to lock or rigidize it in the receiver 110.

With the arrangements described above, the traction can secure the tubular component 30 to the side of the vessel 10. Therefore, dynamic movements of the vessel 10 are not expected to cause relative movement between the tubular component 30 and the support structures (balconies 20a-b, support systems 100, etc.) used to secure the tubular component 30 to the vessel 10. Meanwhile, the receiver 110 and the connector 120 provide lateral stabilization of the tubular component 30, and the locking features on the connector 120 are mechanically actuated to provide the hang-off interface (e.g., a bend limiter 180 for a flexible tubular component 30 or a wear sleeve for a rigid tubular component 30). Moreover, the mechanical actuation of the support system 100 rigidizes the connector 120 to the receiver 110 to improve fatigue performance of the system's components over the life of the installation.

In general, the support system 100 is versatile and can be used with rigid or flexible tubular components 30 with various inner diameters. The support system 100 also has versatility in that it allows interconnections of the tubular components 30 to be made on the port or the starboard side 12 of the vessel 10. The support system 100 can also reduce the length of any rigid ducts required for a subsea assembly because the support system 100 allows connections by keel hauling and optimizes interconnection operations.

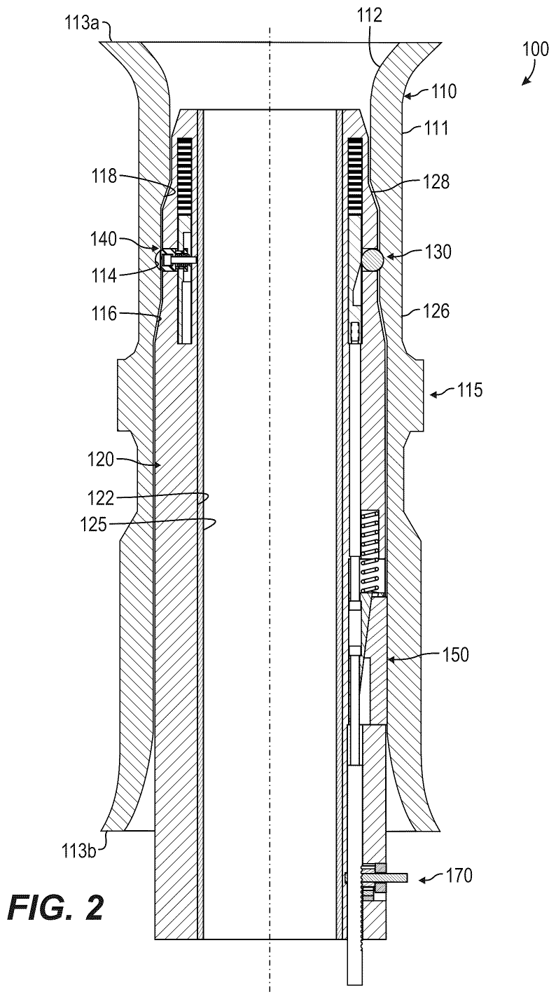

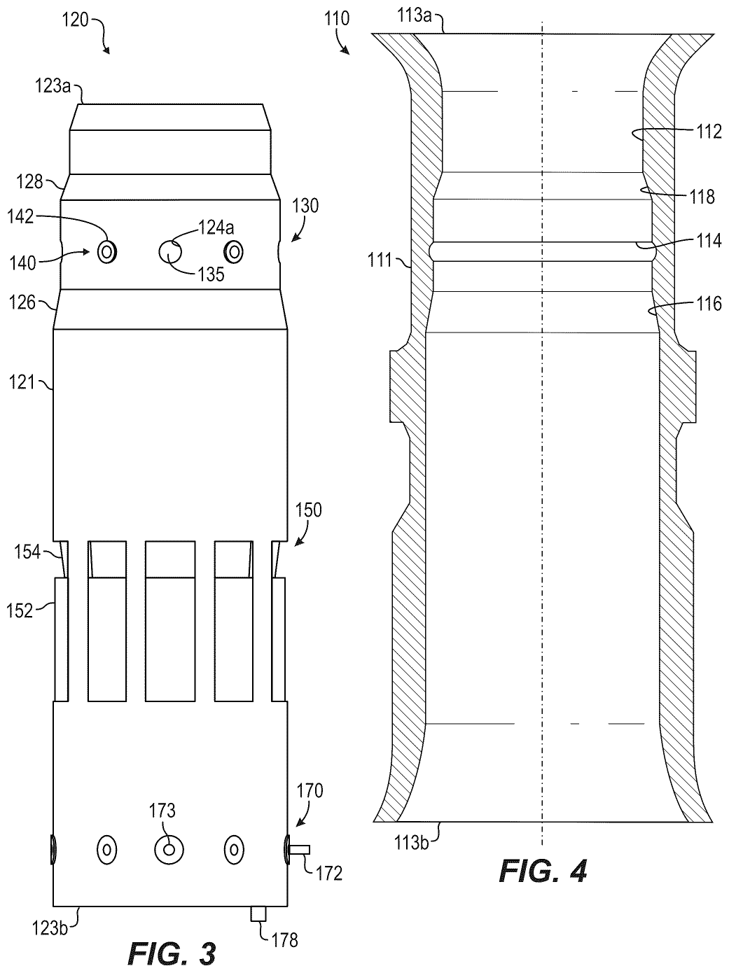

Given the overview above, FIG. 2 illustrates a cross-section of a support system 100 according to the present disclosure. The support system 100 includes a receiver 110 and a connector 120, which can be removably positioned in the receiver 110. In FIG. 2, the connector 120 is shown positioned in the receiver 110. The receiver 110 is configured to be supported on a vessel (not shown). As noted above, for example, the receiver 110 can be supported on a balcony (20a-b) on the side (12) of the vessel (10). For further reference, FIG. 3 shows an elevational view of the connector 120, and FIG. 4 shows a cross-sectional view of the receiver 110.

The receiver 110 has a receiver body 111, which can be cylindrical as shown. The receiver body 111 has an upper end 113a and a lower end 113b and defines a receiver bore 112 therethrough. The receiver body 111 can be an integrated component or may be comprised of several interconnected components for the purposes of assembly. The ends 113a-b can define bell mouths. Other features 115, such as connection flanges, ROV grab handles, and the like, may be provided on the receiver 110 for suitable purposes. Internally, the receiver bore 112 defines an engagement shoulder 116 and a latch profile 114 therein. The receiver bore 112 can also define a stop shoulder 118 toward the upper end 113a.

The connector 120 has a connector body 121, which can be cylindrical as shown. The connector body 121 has an upper end 123a and a lower end 123b and defines a connector bore 122 therethrough. The connector body 121 can be an integrated component or may be comprised of several interconnected components for the purposes of assembly. The connector 120 is disposed on the tubular component (not shown), which passes through the connector bore 122. As noted above and as shown here, an internal wear sleeve 125 can line the connector bore 122 and can protect any coatings or surfaces on the tubular component (not shown) passed through the connector bore 122.

The connector 120 has a latch 130, a trigger 140, and an anchor 150—each of which can be an assembly, a mechanism, or the like and can have one or more components. The latch 130 (e.g., latch assembly) is disposed on the connector 120 and is mechanically movable at least from a retracted condition to an extended condition on the connector 120. The latch assembly 130 in the extended condition is configured to latch in the latch profile 114 in the receiver bore 112.

The trigger 140 (e.g., trigger assembly) is disposed on the connector 120 and is operatively coupled to the latch assembly 130. The trigger assembly 140 is triggered in response to engagement of the trigger assembly 140 with the engagement shoulder 116 when the connector 120 is inserted into the lower end 113b of the receiver 110 and is passed into the receiver bore 112 as the tubular component (not shown) is pulled in the water to the vessel. When triggered, the trigger assembly 140 is configured to mechanically move (trigger, initiate, or instigate movement of) the latch assembly 130 from the retracted condition to the extended condition.

The anchor 150 (e.g., anchor assembly) is disposed on the connector 120 and is operatively coupled to the latch assembly 130. The anchor assembly 150 is configured to mechanically anchor, wedge, or otherwise engage against the receiver bore 112 in response to the latch assembly 130 being moved to the extended condition.

Finally, the connector 120 can further include a lock 170 disposed on the connector 120. Again, the lock 170 can be an assembly, a mechanism, or the like and can have one or more components. The lock 170 (e.g., lock assembly 170) is configured to rigidly lock the anchor assembly 150 engaged inside the receiver bore 112. The lock assembly 170 is operatively coupled to the anchor assembly 150 and is mechanically movable from an unlocked condition to a locked condition. The lock assembly 170 in the locked condition is configured to lock the anchor assembly 150 against the receiver bore 112.

As noted, the receiver bore 112 can define the inner stop shoulder 118 therein. The latch profile 114 is disposed between the engagement shoulder 116 and this inner stop shoulder 118. The connector 120 can include external stop shoulders 126, 128 configured to respectively engage against the inner stop shoulder 118 and the engagement shoulder 116, which limits the insertion of the connector 120 into the receiver bore 112 of the receiver 110.

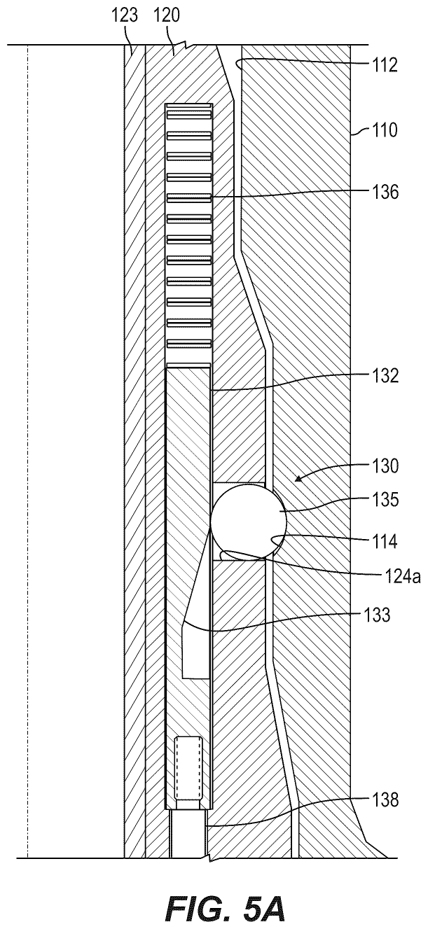

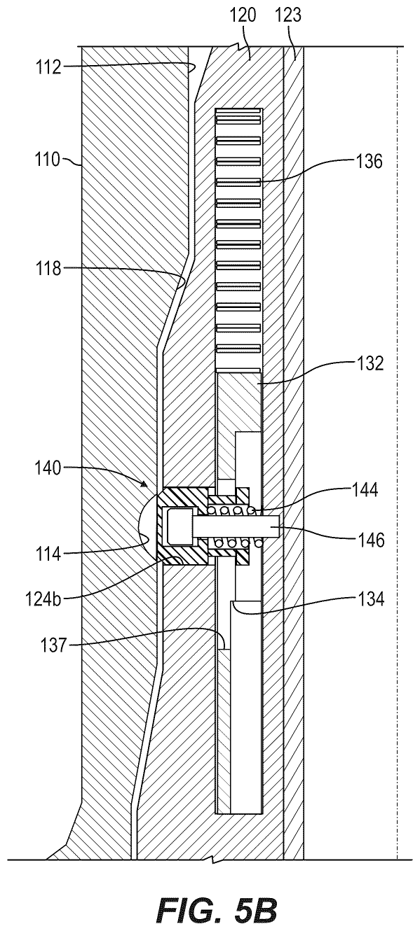

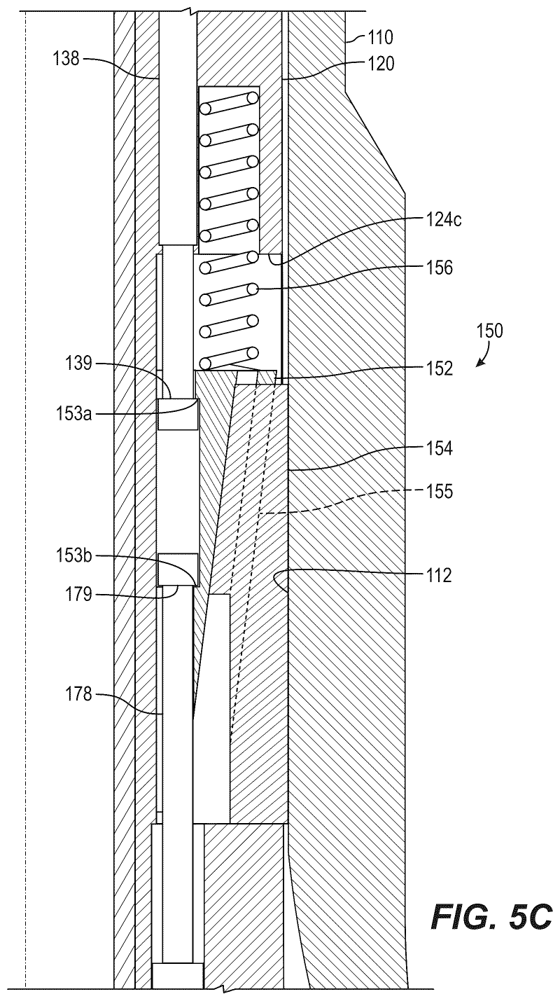

Further details of the assemblies 130, 140, and 150 on the connector 120 are shown in FIGS. 5A-5C. To wit, FIG. 5A illustrates a detailed cross-section of the latch assembly 130 of the connector 120, and FIG. 5B illustrates a detailed cross-section of the trigger assembly 140 of the connector 120. Meanwhile, FIG. 5C illustrates a detailed cross-section of the anchor assembly 150 of the connector 120.

As best shown in FIG. 5A, the latch assembly 130 includes a sleeve 132, a first biasing element or latch spring 136, and at least one latch element or latch dog 135. The sleeve 132 is axially moveable from a first (upper) axial position to a second (lower) axial position (shown) inside a pocket or space of the connector 120. The latch spring 136 biases the sleeve 132 from the first axial position toward the second axial position. The at least one latch dog 135 is disposed in a first side opening 124a of the connector 120 and is laterally moveable from a retracted position when the sleeve 132 in the first axial position to an extended position (shown) when the sleeve 132 in the second axial position.

The at least one latch dog 135 can include a plurality of bearings, balls, or dogs that are disposed in respective ones of the first side openings 124a of the connector 120 and are arranged about a circumference of the connector 120. A slanted pocket 133 in the side of the sleeve 132 can allow the latch dog 135 to move laterally depending on the axial position of the sleeve 132. The first biasing element or latch spring 136 can include one or more coil springs, disc springs, or the like. As only partially shown in FIG. 5A, the sleeve 132 connects to retention rods 138, which extend from the sleeve 132 and operatively connect to the anchor assembly 150 as discussed below.

As best shown in FIG. 5B, the trigger assembly 140 includes a trigger pin 142, a second biasing element or coil spring 144, and a support pin 146. The trigger pin 142 is supported on the support pin 146 disposed on the connector 120, and the trigger pin 142 is disposed in a second side opening 124b of the connector 120. The coil spring 144 biases the trigger pin 142 from a released condition to an engaged condition relative to the second side opening 124b.

The trigger pin 142 in the engaged condition is engaged with the sleeve 132 of the latch assembly 130 and holds the latch assembly 130 in the first axial position. For example, the trigger pin 142 is engaged with a shoulder 134 on the sleeve 132, which holds the sleeve 132 in the upper axial position against the bias of the latch spring 136. As shown, the sleeve 132 can define a longitudinal slot 137 that allows the sleeve 132 to move longitudinally relative to the trigger pin 142, the coil spring 144, and the support pin 146 that pass perpendicularly to the sleeve 132.

As the connector 120 is inserted into the receiver bore 112 as is depicted herein in FIG. 5B, the connector 120 is centralized in the receiver 110. The trigger pin 142 in the engaged condition engages with the engagement shoulder 116 of the receiver bore 112 and moves to the released condition. In the released condition as shown, the trigger pin 142 releases the sleeve 132 to move toward the second axial position. For example, the trigger pin 142 is moved away from the shoulder 134 on the sleeve 132. This allows the latch spring 136 to move the sleeve 132 toward the lower axial position. As the sleeve 132 moves and as best shown in FIG. 5A noted above, the sleeve's slanted pocket 133 pushes the latch dog 135 outward from the side of the connector 120 so the latch dog 135 can engage in the latch profile 114 of the receiver bore 112.

As with the other features on the connector 120, a plurality of the trigger assembly 140 shown in FIG. 5B can be disposed about the circumference of the connector 120. As the connector 120 is inserted into the receiver bore 112 through the lower end (113b), it is possible that one or more of the trigger assemblies 140 may engage against the inner surface of the receiver bore 112, causing the trigger pins 142 to move and to free the shoulder 134 of the sleeve 132 from support. To prevent premature activation, all of the trigger assemblies 140 disposed about the circumference of the connector 120 must be triggered together so the latch assembly 130 can be released. This ensures that triggering is not achieved until the connector 120 is fully inserted in the receiver bore 112 and each of the trigger pins 142 can engage the engagement shoulder 116 together while the connector 120 is inserted in the receiver bore 112.

As best shown in FIG. 5C, the anchor assembly 150 uses a slip or wedge arrangement to anchor inside the receiver bore 112. In particular, the anchor assembly 150 includes an activation wedge 152, a third biasing element or activation spring 156, and an engagement wedge 154. The activation and engagement wedges 152, 154 have complementary wedging surfaces and may be interleaved with one another by using interleaved tracks 155 and edges. The activation wedge 152 is axially moveable at least from an inactive position to an active position on the connector 120, and the activation spring 156, which can be a coil spring, biases the activation wedge 152 from the inactive position toward the active position. As shown here, the active position corresponds to the activation wedge 152 being in a lower position with the activation wedge 152 more interleaved with the engagement wedge 154. This is in contrast to the inactive position in which the activation wedge 152 is in an upper position with the activation wedge 152 less interleaved with the engagement wedge 154.

Meanwhile, \the engagement wedge 154 is disposed in a third side opening 124c of the connector 120 and is laterally moveable from an unanchored, unwedged, or disengaged position (when the activation wedge 152 is in the inactive position) to an anchored, wedged, or engaged position (when the activation wedge 152 is in the active position). The engagement wedge 154 in the wedged position can anchor, wedge, or otherwise engage against the receiver bore 112.

As noted above, the latch assembly (130; FIG. 5A) is operatively coupled to the anchor assembly 150. In particular, the latch assembly (130) includes a retention rod 138 that extends from the sleeve (132). The retention rod 138 is moveable axially with the movement of the sleeve (132) from the first axial position to the second axial position. The retention rod 138 with the sleeve (132) in the first axial position holds the activation wedge 152 in the inactive position. For example, a shoulder 139 on the retention rod 138 engages a shoulder 153a on the activation wedge 152. This holds the activation wedge 152 in the inactive position and prevents the activation spring 156 from moving the activation wedge 152. When the sleeve (132) is moved to its second axial position, the retention rod 138 also moves, which releases the activation wedge 152 so the activation spring 156 can move the activation wedge 152 to the active position.

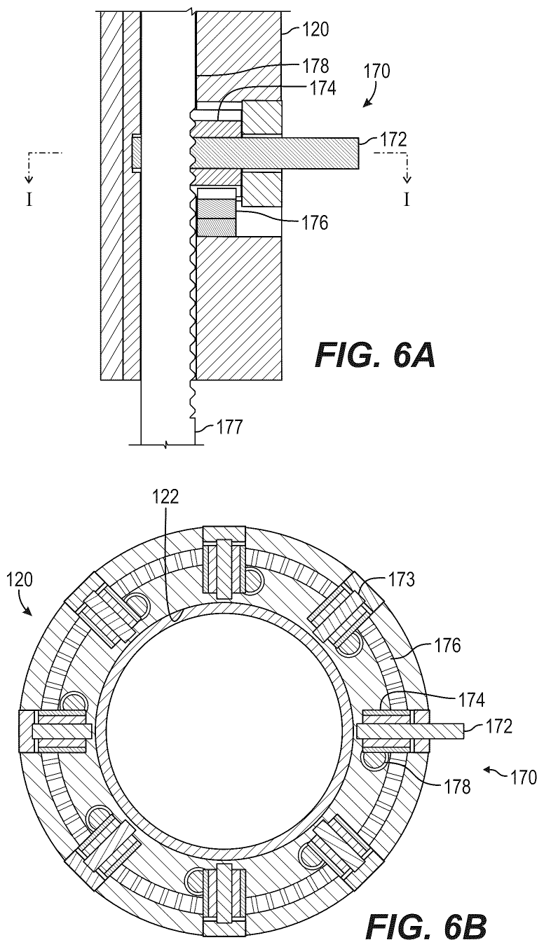

Turning now to the lock assembly 170, FIG. 6A illustrates a detailed cross-section of the lock assembly 170 of the connector 120, and FIG. 6B illustrates an end-section of the connector 120, taken generally along line I-I in FIG. 6A. As best shown in FIG. 6A, the lock assembly 170 includes a drive shaft 172, a pinion gear 174, and a lock rod 178. The drive shaft 172 extends from the connector 120 and is rotatable at least in a first direction. For example, an ROV can engage the drive shaft 172 to turn the drive shaft 172 after (i) the connector 120 has been inserted into the receiver 110, (ii) the latch assembly (130; FIG. 5A) has been latched, and (iii) the anchor assembly (150; FIG. 5C) has been initially anchored in the receiver 110.

The pinion gear 174 is rotatable with the rotation of the drive shaft 172. The lock rod 178 has a rack gear 177 engaged with the pinion gear 174. The lock rod 178 is axially moveable between an unlocked position and a locked position in response to the rotation of the pinion gear 174. As will be appreciated, various bearings, support elements, and other features (not explicitly shown) may be provided for the components of the lock assembly 170.

As also noted above, the lock assembly 170 is operatively coupled to the anchor assembly 150. As shown in FIG. 5C, the lock rod 178 in the unlocked position has a first lock surface or shoulder 179 disengaged from a second lock surface or shoulder 153b of the activation wedge 152. When the lock rod 178 is moved to a locked position, the first lock surface 179 is engaged with the second lock surface 153b of the activation wedge 152. This engagement prevents movement of the activation wedge 152 from its activation position, thereby locking the engagement wedge 154 engaged against the receiver bore 112.

As hinted above, the anchor assembly 150 of FIG. 5C includes a plurality of the activation wedge 152 and the engagement wedge 154 disposed about a circumference of the connector 120. To lock the plurality of the engagement wedges 154, the lock assembly 170 as shown in FIG. 6B includes a circumferential gear rack 176, a plurality of second pinion gears 174, and a plurality of second lock rods 178. The second pinion gears 174 are disposed on bearing shafts 173 and are engaged between the circumferential gear rack 176 and the rack gears on the second lock rods 178, which are operatively connected to respective anchor assemblies 150.

The circumferential gear rack 176 is disposed on the connector 120 and is engaged with the pinion gears 174. The circumferential gear rack 176 can be rotatable about the circumference of the connector 120 when the drive shaft 172 rotates its pinion gear 174. As a result, the following pinion gears 174 engaged with the circumferential gear rack 176 are also rotated about their bearing shafts 173 so the additional lock rods 178 can be moved axially in the manner noted above to lock their respective engagement wedges 154.

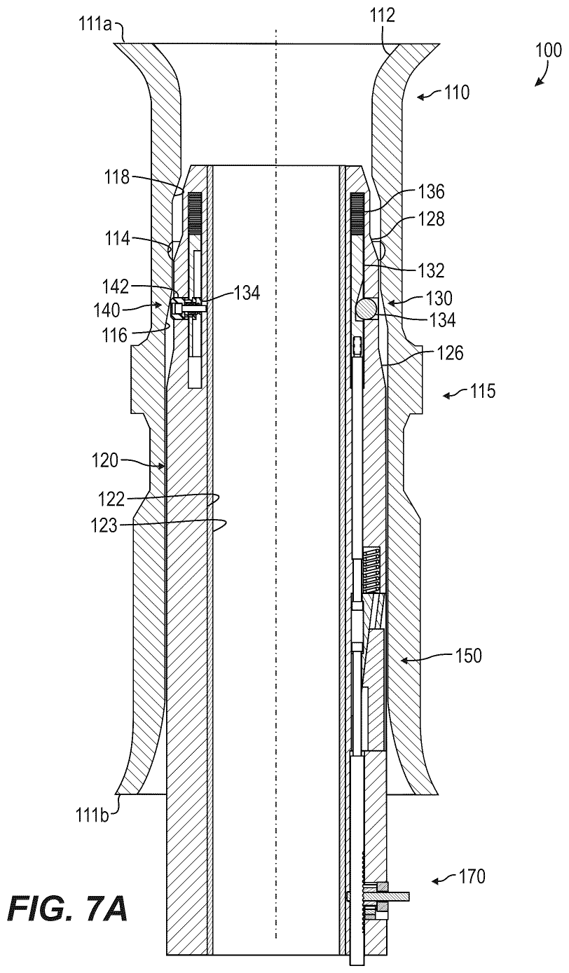

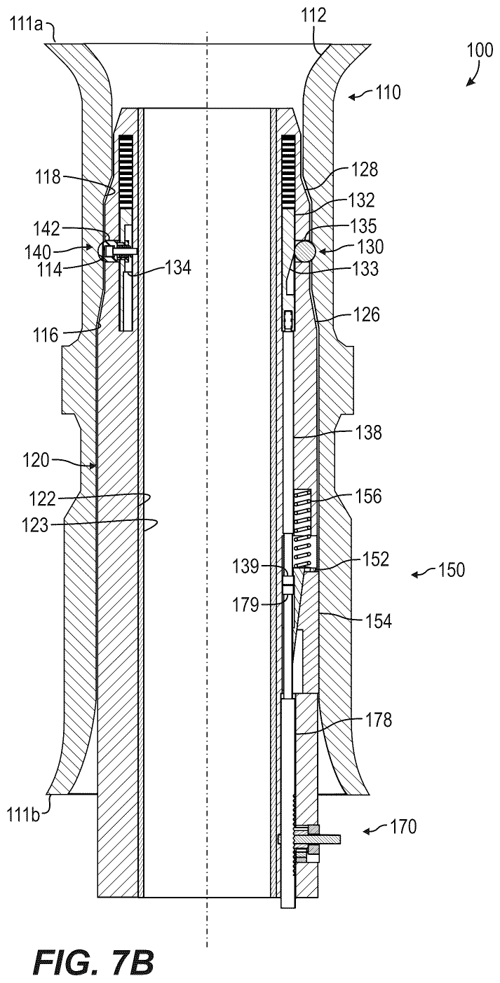

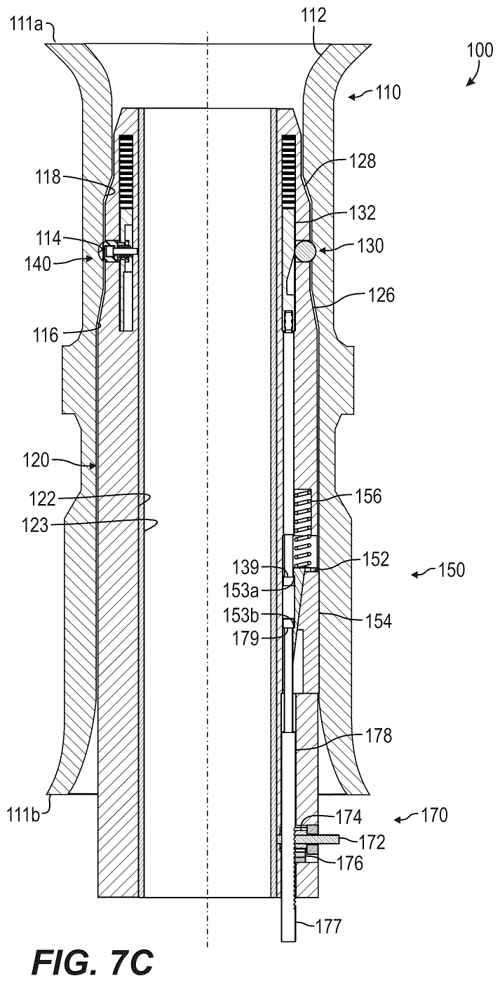

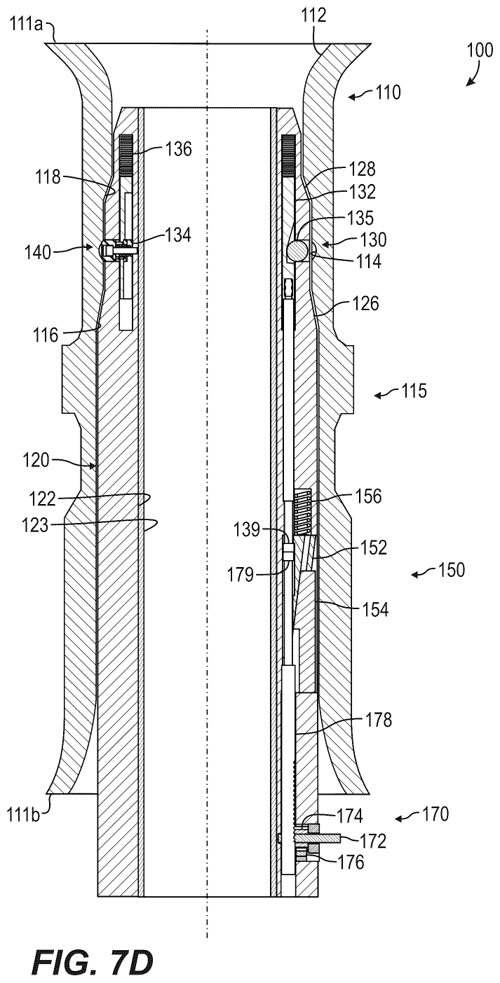

Given the details described above, discussion now turns to the process for connecting the support system 100. To that end, FIGS. 7A-7C show the process for connecting the connector 120 inside the receiver 110 to support a tubular component (not shown).

Initially, FIG. 7A illustrates a cross-section of the receiver 110 receiving the connector 120. The receiver 110 is supported on the vessel (10), and the connector 120 is already disposed on the tubular component (not shown). The tubular component (30) is passed through the receiver bore 112 until the connector 120 on the tubular component (30) is inserted into the lower end 113b of the receiver bore 112. When the connector 120 is inserted to an appropriate extent inside the receiver bore 112, the trigger assembly 140 can be triggered in response to engagement of the trigger assembly 140 with the engagement shoulder 116 inside the receiver bore 112. As noted, all the trigger assemblies 140 disposed about the circumference of the connector 120 may need to be triggered together so the latch assembly 130 can be released.

When triggering the trigger assembly 140, the latch assembly 130 is initially held in the first axial (upward) position by biasing the trigger pin 142 disposed in the second side opening (124b) of the connector 120 to the engaged condition. The trigger pin 142 in the engaged condition is engaged with the shoulder 134 of the sleeve 132 of the latch assembly 130, which prevents movement of the sleeve 132. In the triggering process, the sleeve 132 is then released to move toward the second axial (lower) position when the trigger pin 142 engages against the engagement shoulder 116 and the trigger pin 142 moves from the engaged condition to a released condition away from the sleeve's shoulder 134. Once the trigger assembly 140 is released, the sleeve 132 biased by the latch spring 136 is urged downward and attempts to push the latch dogs 135 radially outward.

FIG. 7B now illustrates a cross-section of the receiver 110 during the initial latching of the connector 120. Eventually, as the connector 120 is inserted into the receiver bore 112 as shown here, the external stop shoulder 128 on the connector 120 engages against the inner stop shoulder 118 defined in the receiver bore 112. In response to the triggering discussed above, the connection process involves releasing the latch assembly 130, moving the latch assembly 130 from a retracted condition to an extended condition on the connector 120, and latching the latch assembly 130 in the extended condition. In particular, the sleeve 132 is released by the triggering of the trigger assembly 140. To then latch, the released sleeve 132 moves axially from the upper axial position to the lower axial position on the connector 120 by the bias on the sleeve 132 provided by the latch spring 136. The at least one latch dog 135 (e.g., bearing, ball, or other latch element) disposed in the first side opening (124a) of the connector 120 moves laterally from a retracted position (when the sleeve 132 in the upper axial position) to an extended position (when the sleeve 132 in the lower axial position as shown) so the at least one latch dog 135 can engage in the latch profile 114 in the receiver bore 112.

In response to the latch assembly 130 moving to the extended condition, the anchor assembly 150 disposed on the connector 120 is anchored against the receiver bore 112. As discussed above, anchoring of the anchor assembly 150 involves: initially holding the activation wedge 152 in an inactive position biased toward an active position on the connector 120; releasing the activation wedge 152 to move from the inactive position toward the active position as shown here in response to the movement of the sleeve 132 toward the lower axial position; and wedging an engagement wedge 154 disposed in a third side opening (124c) of the connector 120 by moving the engagement wedge 154 laterally from an unwedged position (when the activation wedge 152 in the inactive position) to a wedged position (when the activation wedge 152 in the active position as shown).

In releasing the activation wedge 152 to move in response to the movement of the sleeve 132 toward the lower axial position, the activation wedge 152 is initially held in the inactive position with the shoulder 139 of the retention rod 138 extending from the sleeve 132 and engaged with the shoulder 153a of the activation wedge 152. The retention rod 138 moves axially with the movement of the sleeve 132 from the upper axial position to the lower axial position so the activation wedge 152 is released to move by the bias of the activation spring 156 to the active position with the movement of the retention rod 138.

FIG. 7C now illustrates a cross-section of the receiver 110 during final latching of the connector 120. In the latching process, the anchor assembly 150 can be locked against the receiver bore 112 by moving the lock assembly 170 disposed on the connector 120 from an unlocked condition to a locked condition. To move the lock assembly 170, the drive shaft 172 extending from the connector 120 is rotated in a first direction. The pinion gear 174 rotates with the rotation of the drive shaft 172, and the lock rod 178 having the rack gear 177 engaged with the pinion gear 174 moves axially from an unlocked position to a locked position in response to the rotation of the pinion gear 174. Movement of the activation wedge 152 from the activation position is now prevented by the engagement of a first lock surface 179 on the lock rod 178 against a second lock surface 153b of the activation wedge 152.

As noted, the anchor assembly 150 includes a plurality of the activation wedge 152 and the engagement wedge 154 disposed about a circumference of the connector 120. Therefore, moving the lock assembly 170 includes: rotating a circumferential gear rack 176 disposed on the connector 120 engaged with the pinion gear 174; rotating a plurality of second pinion gears 174 engaged with the circumferential gear rack 176; moving a plurality of second lock rods 178 having a second rack gear 177 engaged with the second pinion gears 174 axially from the unlocked position to the locked position in response to the rotation of the second pinion gear 174; and preventing movement of the activation wedges 152 from the activation position by engaging the first lock surfaces 179 on the second lock rod 178 against the second lock surfaces 153b of the second activation wedges 152.

At some point during use, the connector 120 may need to be released from the receiver 110 to conduct maintenance, to install new lines, or to achieve any other purpose. To that end, the support assembly 100 allows for disconnection of the receiver 110 and the connector 120. FIG. 7D illustrates a cross-section of the receiver 110 during disconnection of the connector 120. As shown, the lock assembly 170 is movable from the locked condition to a released condition. The lock assembly 170 in the released condition is then configured to move the activation wedge 152 from the active position to the inactive position. Furthermore, the lock assembly 170 in the released condition is also configured to move the sleeve 132 from the second axial position to the first axial position on the connector 120.

In particular, the drive shaft 172 can be rotated in a second direction opposite to the first direction. The pinion gear 174 rotates in reverse with the rotation of the drive shaft 172 in the second direction, and the lock rod 178 is moved axially (upward) from the locked position (as shown in FIG. 7C) to a released position (as shown here) in response to movement of the rack gear 177 by the rotation of the pinion gear 174. The lock rod 178 in the released position engages the retention rod 138 of the latch assembly 130, moves the activation wedge 152 from the active position to the inactive position by engagement of the shoulder 139 with the activation wedge's shoulder 153a, and moves the sleeve 132 of the latch assembly from the second axial position to the first axial position. The latch dogs 135 in the first side openings (124a) are now unsupported by the sleeve 132 and can disengage from the latch profile 114 in the receiver bore 112.

The lock assembly 170 can be released from the locked condition to the released condition by moving the activation wedge 152 from the active position to the inactive position and moving the sleeve 132 from the second axial position to the first axial position on the connector 120. To release the lock assembly 170, the drive shaft 172 is rotated in a second direction opposite to the first direction. The pinion gear 174 rotates with the rotation of the drive shaft 172 in the second direction. The lock rod 178 having the rack gear 177 engaged with the pinion gear 174 moves axially upward from the locked position to the released position in response to movement of the rack gear 177 by the rotation of the pinion gear 174. The lock rod 178 in the released position engages against the retention rod 138 and pushes it upward. The upward movement of the lock rod 178 moves the activation wedge 152 from the active position to the inactive position and also moves the sleeve 132 from the second axial position to the first axial position. The slanted pocket 133 allows the latch dog 135 to retract from the latch profile 114.

After disconnection, the connector 120 can be removed from the receiver 110, which can be done for any suitable purpose. The support system 100 can then be reconnected when needed. For example, the lock assembly 170 can be reset to an initial condition, such as shown in FIGS. 2, 5C and 7A-7C, to allow for the retention rod 138 to move and to allow the trigger assembly 140 to be set for triggering.

As shown in FIGS. 8A-8C, different types of tubular components can be used with the disclosed support system 100. For example, FIG. 8A illustrates a cross-section of a receiver 110 having a connector 120 supporting an umbilical or a flexible pipe 35, and FIG. 8B illustrates a cross-section of the receiver 110 having a connector 120 supporting a power cable 37. Different diameters of the tubular components can be accommodated by using liners, spacer, or the like in the connector bores 122 or by using connectors 120 having different sized connector bores 122 for particular tubular diameters. Meanwhile, FIG. 8C illustrates a cross-section of the receiver 110 having a connector 120 supporting a rigid tubular 36.

For some of the tubular components, such as the umbilical or the flexible pipe 35 and the power cable 37 of FIGS. 8A-8B, the support system 100 as noted above provides a hang-off interface, which can include a bend stiffener or bend limiter 180. As shown here, the connector 120 can include a bend limiter 180 extending from the lower end 123b of the connector 120 to limit bending of the tubular component (30, 35, 37) extending from the lower end 123b of the connector 120. The bend limiter 180 can include a bend stiffener 184 connected by a fixture 182 to the lower end 123b of the connector 120.

For rigid tubular components as noted above, the support system 100 provides an interface for hang-off of a riser pipe support with an internal wear surface. As shown in FIG. 8C, for example, the connector 120 fills the gap between the receiver bore 112 and the outside diameter of a rigid tubular 36 after larger sections of a riser (not shown) have passed through the receiver 110. The internal wear sleeve 125 lines the connector bore 122 and can protect coatings and surfaces of the riser.

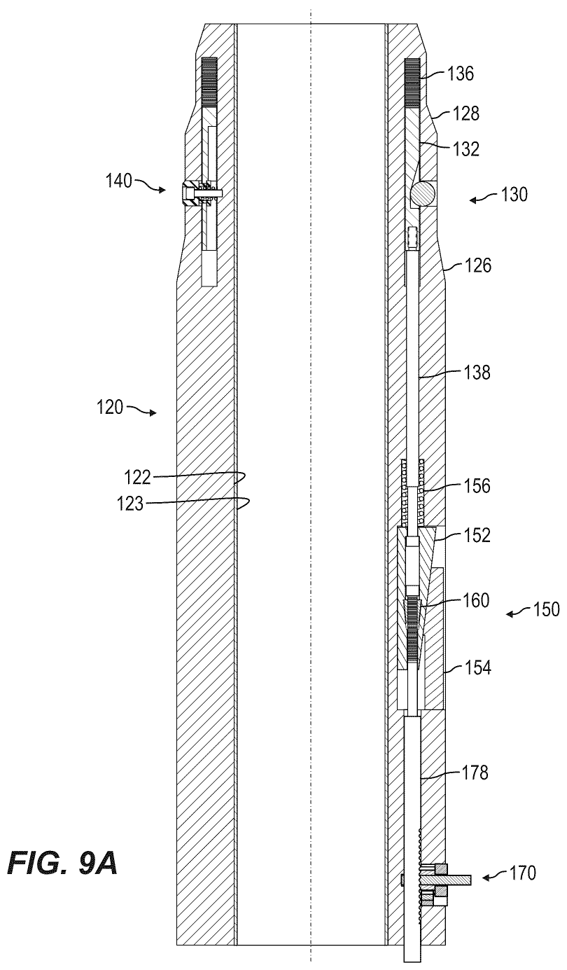

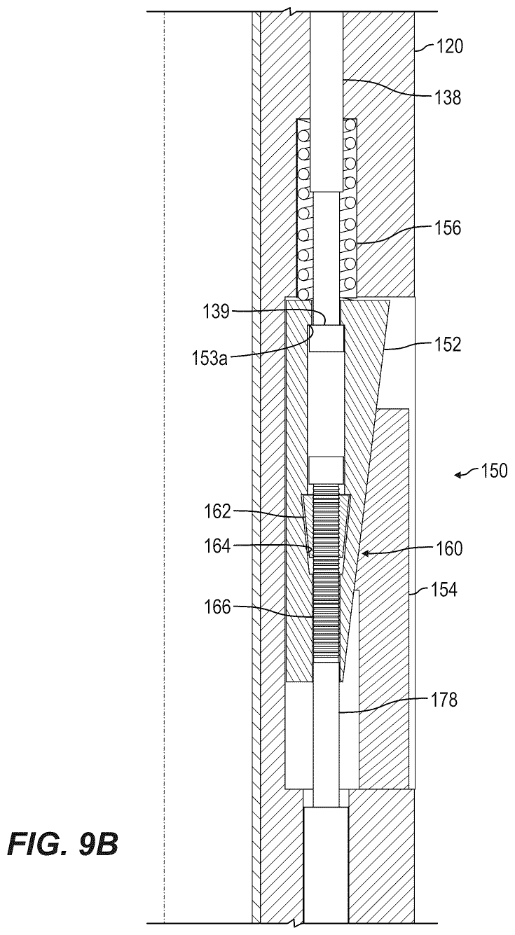

FIG. 9A illustrates a cross-section of another connector 120 for a support system (100) according to the present disclosure. Details of this connector 120 are similar to those discussed previously so the same reference numerals are used for similar components. The connector 120 has a latch 130, a trigger 140, an anchor 150, and a lock 170—each of which can be an assembly, a mechanism, or the like having one or more components. Each of these is similar to the previous arrangement. As noted above and as shown here, an internal wear sleeve 125 can line the connector bore 122 and can protect any coating or surface on a tubular component (not shown) passed in the connector bore 122.

As before, the latch assembly 130 is operatively coupled to the anchor assembly 150 using the retention rod 138, which is used to hold the activation wedge 152 in the inactive position against the bias of the activation spring 156. Additionally, the lock assembly 170 is operatively coupled to the anchor assembly 150 using the lock rod 178, which can further move and lock the activation wedge 152 toward the active position beyond the bias force of the activation spring 156. The connector 120 as before can include a plurality of the features for the latch assembly 130, the trigger assembly 140, the anchor assembly 150, and the lock assembly 170 disposed about the circumference of the body of the connector 120.

The present connector 120 further includes a slip assembly 160, which is used in connection with the anchor and latch assemblies 130, 150. The slip assembly 160 can be an assembly, a mechanism, or the like having one or more components. The slip (e.g., slip assembly) 160 is used between the activation wedge 152 and the lock rod 178. Further details are provided below.

Turning now to FIG. 9B, the slip assembly 160 includes a plurality of slip elements 162 arranged between the activation wedge 152 and the lock rod 178. The activation wedge 152 defines a cone opening having an inclined surface 164, and the lock rod 178 defines a ratchet surface 166. The slip elements 162 are disposed between the inclined surface 164 and the ratchet surface 166 so the slip elements 162 can fit in the cone opening having the inclined surface 164 and are disposed circumferentially about the ratchet surface 166. The slip elements 162 are configured to grip between the inclined surface 164 and the ratchet surface 166 when the lock rod 178 is moved toward the locked position. By contrast, the slip elements 162 are configured to release between the inclined surface 164 and the ratchet surface 166 when the lock rod 178 is moved toward the unlocked position.

In FIG. 9B, the components are shown in the arrangement for insertion of the connector 120 into the receiver bore (112) of the receiver (110). The shoulder 139 of the retention rod 138 engages the shoulder 153a of the activation wedge 152 and holds the activation wedge 152 in the inactive position against the bias of the activation spring 156. The lock rod 178 is in its unlocked position.

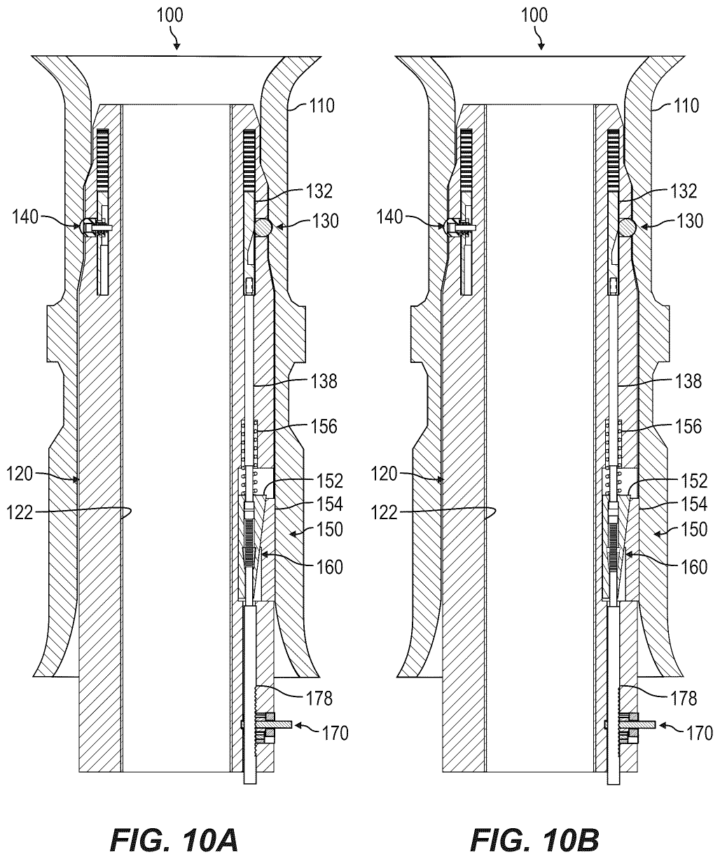

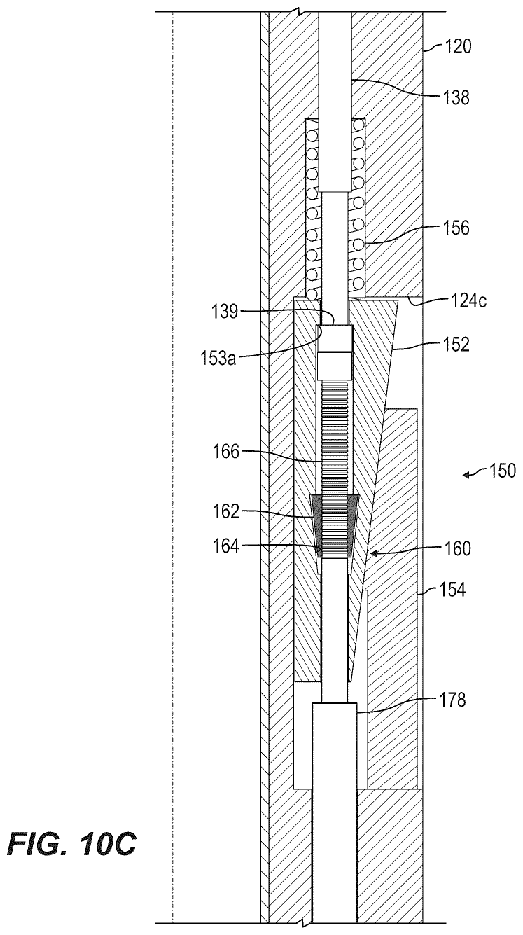

Initial latching of the connector 120 in the receiver 110 is shown in FIG. 10A. The trigger assembly 140 is triggered engagement inside the receiver bore 112. In response to the triggering, the connection process involves releasing the latch assembly 130, moving the latch assembly 130 from a retracted condition to an extended condition on the connector 120, and latching the latch assembly 130 in the extended condition. In response to the moving of the latch assembly 130 in the extended condition, the anchor assembly 150 disposed on the connector 120 is anchored against the receiver bore 112. In particular, the release of the sleeve 132 moves the retention rod 138 so the activation wedge 152 can move from the inactive position toward the active position by the bias of the activation spring 156. The engagement wedge 154 moves laterally from an unwedged position to a wedged position against the surface of the receiver bore 112. During movement of the activation wedge 152, the slip assembly 160 can move along the lock rod 178 with the movement of the activation wedge 152.

Final latching of the connector 120 in the receiver 110 is shown in FIG. 10B. In the process, the anchor assembly 150 is locked against the receiver bore 112 by moving the lock assembly 170 disposed on the connector 120 from an unlocked condition to a locked condition. As before, the drive shaft 172 extending from the connector 120 is rotated, which rotates the pinion gear 174 and moves the lock rod 178 having the rack gear 177 engaged with the pinion gear 174 axially from an unlocked position to a locked position. As the lock rod 178 moves, the ratchet engagement between the rod's ratchet surface (166) and the slip elements (162) of the slip assembly 160 pulls the slip elements (162) further into the inclined surface (164) of the cone opening in the activation wedge 152. As a result, the slip elements (162) grip between the rod's ratchet surface (166) and the wedge's inclined surface 164, preventing movement of the activation wedge 152 from the activation position and further locking the engagement wedge 154 engaged in the receiver bore 112.

As noted herein, the anchor assembly 150 includes sets of activation wedges 152 and the engagement wedges 154 disposed about the circumference of the connector 120. As each corresponding engagement wedge 154 moves laterally into engagement with the receiver bore 112 across the annular gap between the connector 120 and the receiver bore 112, each activation wedge 152 can move independently to its respective activation position along the ratchet surface (166) of its respective lock rod 178. The slip assembly 160 of each activation wedge 152 can also move independently along the ratchet surface (166) of the respective lock rod 178 to engage the inclined surface (164). As a result, each slip assembly 160 provides an adjustable engagement point between its respective lock rod 178 and activation wedge 152 so the lock assembly 170 when activated can pull down evenly on each activation wedge 152.

For example, when the connector 120 is installed in the receiver 110, the tubular component 30 (e.g., riser) disposed in the connector 120 will impart side loads on the connector 120. One portion of an annular gap between the connector 120 and the receiver bore 112 may be narrower than another portion. Consequently, as the anchor assembly 150 is actuated, the activation wedges 152 disposed about the circumference of the connector 120 work independently of one another. The activation wedges 152 will move different distances along its respective lock rod 178 as the engagement wedges 154 fill the respective annular gaps to the receiver bore 112. The distance that each activation wedge 152 moves will be dictated by the respective annular gap that the corresponding engagement wedge 154 moves from the connector 120 to the receiver bore 112. The ability of each activation wedge 152 and slip assembly (160) to slide down the ratchet surface (166) of the respective lock rod 178 allows the lock assembly 170 to pull down evenly on each activation wedge 152, regardless of its engagement and elevation. This allows the engagement wedges 154 to fill their respective annular gap without needing first to strictly centralize the connector 120 in the receiver 110, which may not be possible due to the side loads imparted by the tubular component (not shown) on the connector 120.

The other lock assembly 170 of the previous arrangements can also work independently of one another to some extent, by providing additional drive pins and separate geared arrangements for the lock rods 178.

Disconnection of the connector 120 from the receiver 110 can be achieved as shown in the detail of FIG. 10C. As before, the drive shaft (172) can be rotated in an opposite direction so the pinion gear (174) rotates and moves the lock rod 178 axially from the locked position to a released position. As the lock rod 178 moves, the ratcheting between the ratchet surface 166 and the slip elements 162 releases the gripping of the slip elements 162. The lock rod 178 in the released position engages the retention rod 138, moves the activation wedge 152 from the active position to the inactive position by engagement of the shoulder 139 with the activation wedge's shoulder 153a, and moves the sleeve (132) from the second axial position to the first axial position.

After disconnection, the connector 120 can be removed from the receiver 110, which can be done for any suitable purpose. The support system 100 can then be reconnected when needed. For example, the lock assembly 170 can be reset to an initial condition, such as shown in FIGS. 9A-9B and 10A-10B, to allow for the retention rod 138 to move and to allow the trigger assembly 140 to be set for triggering.

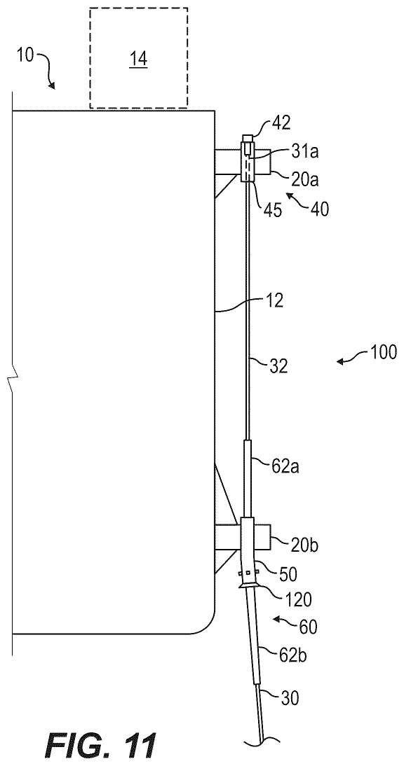

FIG. 11 illustrates an end view of a side 12 of a vessel 10 having upper and lowers balconies 20a-b. A support system 100 of the present disclosure on the vessel 10 supports a tubular component 30 used for communicating between the vessel 10 and components in a subsea environment. Again, the vessel 10 can be a floating production storage and offloading (FPSO) unit or another type of structure and vessel. The tubular component 30 can be a flowline, such as a rigid riser.

As noted previously, the upper and lower balconies 20a-b extend from the side 12 of the vessel 10 to support the rigid riser 30. The lower balcony 20b may be situated below the minimum draft of the vessel 10, and the upper balcony 20a may be supported close to the deck level of the vessel 10. The balconies 20a-b of the vessel 10 include upper and lower receivers 40, 50 respectively, which may be designed to support a flexible riser and not the rigid riser 30. The support system 100 of the present disclosure includes a pipe support 60 and the connector 120. Even though the receivers 40, 50 may be designed for use with a flexible riser, the pipe support 60 and the connector 120 are used with the receivers 40, 50 to support the rigid riser 30 without the need to modify the receivers 40, 50.

The upper receiver 40 is supported on the upper balcony 20a and includes an I-tube and a top interface spool or a hang-off interface 42. The lower receiver 50 is supported on the lower balcony 20b and can be vertically straight. Alternatively, as shown, the lower receiver 50 can be angled or oriented away from vertical to disperse or spread the rigid riser 30 as it extends below the vessel 10.

During installation of the rigid riser 30, equipment 14 on the vessel 10 can include a pull-in platform (not shown), which can be located above the upper balcony 20a and can be used to pull in an upper section 32 of the rigid riser 30 through the receivers 40, 50 on the balconies 20a-b. Using a pull-in operation, for example, the rigid riser 30 can be pulled from the water to connect to the vessel 10 using the pull-in platform of the equipment 14. A pull-in wire can be connected by a pull-in head to a termination 31a of the riser section 32. For example, this riser section 32 can include a transition spool or flange for the termination 31a, and the riser section 32 can be made up of one or more flanged riser pipes connected to the upper stress joint 62a. The riser section 32 can be passed through the lower receiver 50 on the lower balcony 20b until reaching the upper receiver 40 on the upper balcony 20a.

The lower stress joint 62b of the pipe support 60 is connected to the rigid riser 30. The pipe support 60 is in turn disposed inside the connector 120. After the upper section 32 of the rigid riser 30 and upper stress joint 62a of the pipe support have passed through the lower receiver 50, the connector 120 enters the receiver 50. Upon entering, the connector 120 actuates inside the receiver 50. When actuated, for example, the connector 120 mechanically anchors inside the lower receiver 50. Meanwhile, the termination 31a of the riser section 32 is connected to the hang-off interface 42 located on the upper receiver 40 at the deck of the vessel 10.

Once the connector 120 has been anchored, diverless operations can be performed to mechanically lock or rigidize the connector 120 in the lower receiver 50. For example, a remote operated vehicle (ROV) can be deployed below the water line to mechanically operate locking features on the connector 120 to lock or rigidize the connector 120 in the lower receiver 50.

As can be seen, the connector 120 fills the gap between a bore of the lower receiver 50 and an outer diameter (OD) of the pipe support 60, which is connected to the riser. The pipe support 60 can have an articulable coupling (not visible here) between stress joints 62a-b so the pipe support 60 can accommodate the angle of the lower receiver 50.

The lower stress joint 62b can be tapered to handle stress and to provide flexibility at the connection point between the rigid riser 30 and the vessel 10. The distal end of the lower stress joint 62b can be welded to the top end of the rigid riser 30, providing a permanent connection. Alternatively, a flanged or other mechanical connection may be used. The upper stress joint 62a can also be tapered so it can be flexed to connect the upper section 32 of the rigid riser 30 to the hang-off interface 42.

Weight of the rigid riser 30 can be carried by the termination 31a at the hang-off interface 42 at the upper balcony 20a. Additionally, the connector 120 in the lower receiver 50 at the lower balcony 20b includes support features (e.g., wedges) that rigidize the connector 120 to the lower receiver 50 and subsequently limit the movement of the lower stress joint 62b inside the connector 120, improving the fatigue life of the stress joints 62a-b and the assembly of connector 120 with the receiver 50.

The arrangement described above completes the traction support to secure the rigid riser 30 to the side of the vessel 10. Therefore, dynamic movements of the vessel 10 are not expected to cause relative movement between the rigid riser 30 and the support structures (balconies 20a-b, support system 100, etc.) used to secure the rigid riser 30 to the vessel 10. Meanwhile, the lower receiver 50 and the connector 120 provide lateral stabilization of the rigid riser 30, and the features on the connector 120 are mechanically actuated to provide a hang-off interface.

Moreover, the mechanical actuation of the support system 100 rigidizes the connector 120 to the lower receiver 50 to improve fatigue performance of the system's components over the life of the installation.

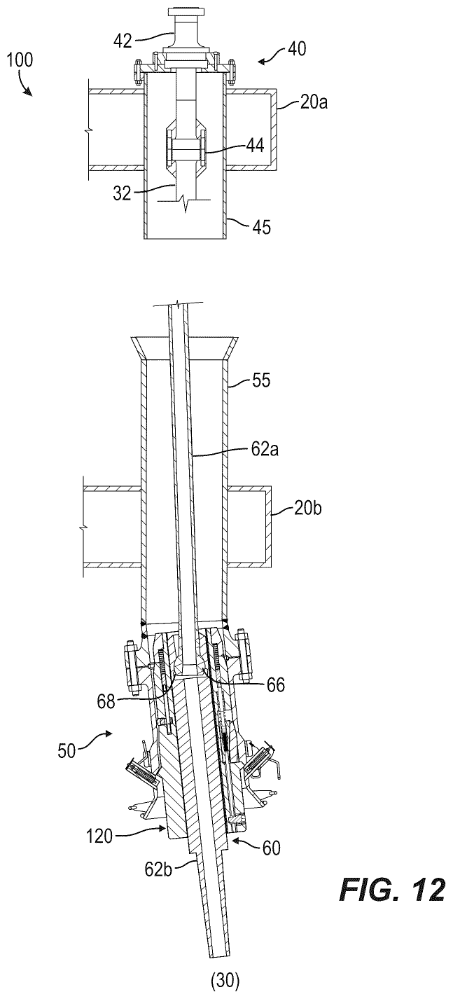

FIG. 12 illustrates a cross-sectional view of the support system 100 in FIG. 11 at the upper and lower balconies 20a-b for the vessel. As noted above, the support system 100 includes the connector 120 installed into the lower receiver 50, which is supported at the lower balcony 20b of the vessel. The lower receiver 50 may be an existing component on the vessel and can be similar to a bend stiffener receptacle disclosed in WO2019/232605 and WO 2023/028680.

An I-tube 55 is mounted with a flange to the top of the lower receiver 50 and extends upward toward the upper receiver 40 at the upper balcony 20a. The upper receiver 40 includes a hang-off interface 42 and an I-tube 45. The hang-off interface 42 can include a riser split flange hang-off interface.

The connector 120 installed in the lower receiver 50 has the pipe support 60 installed in the bore of the connector 120. As noted, the pipe support 60 has an upper stress joint 62a and a lower stress joint 62b. A lower section of the rigid riser (30) extends in the water from lower stress joint 62b, which can be tapered. As noted above, the pipe support 60 can have an articulable coupling 64 between the stress joints 62a-b so the pipe support 60 can accommodate the angle of the lower receiver 50. For example, the upper stress joint 62a can include a ball swivel 66 installed in a socket 68 of the lower stress joints 62b. The ball swivel 66 and socket 68 allow for relative orientation of the stress joints 62a-b. The upper stress joint 62a extends toward the I-tube 55 so the communication of the rigid riser 30 can extend to the upper balcony 20a. At the upper balcony 20a, for example, an upper section 32 of the rigid riser 30, which can be connected to the upper stress joint 62a, connects with a connector 44 to the hang-off interface 42 inside the I-tube 45. (If the upper stress joint 62a is long enough, then an upper end of the upper stress joint 62a can connect with the connector 44 to the hang-off interface 42.) In this configuration, the support system 100 can support the weight of rigid riser 30 and can centralize the upper stress joint 62a inside the I-tube 45, minimizing movement between the ball swivel 66 and socket 68.

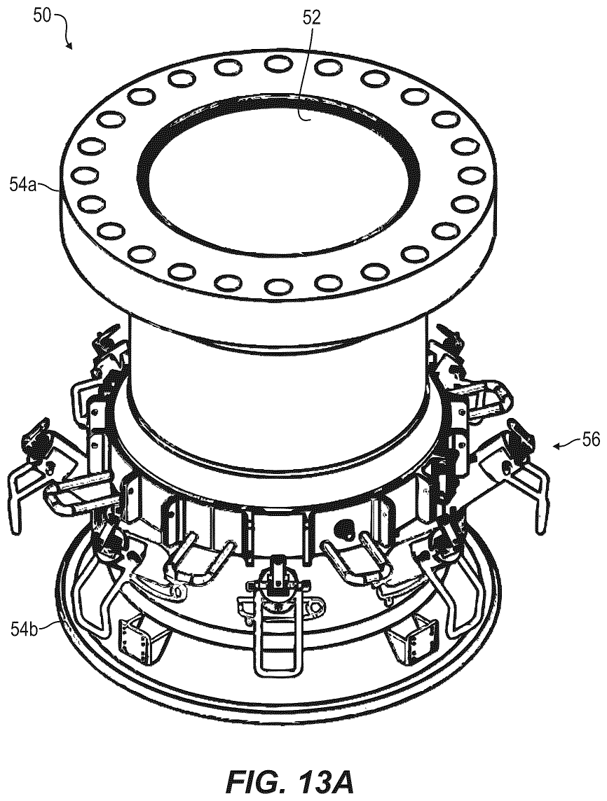

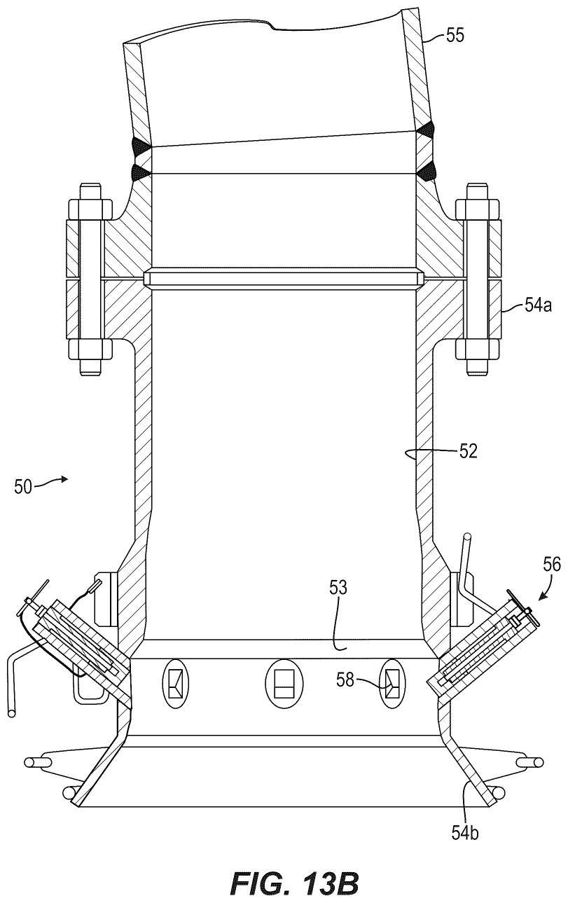

FIGS. 13A-13B illustrates a perspective view and a cross-sectional view of the lower receiver 50 of FIG. 12. The lower receiver 50 includes a receptacle body, which can have a bellmouth 54b at the lower end and can have a flange 54a at the upper end. Spring loaded assemblies 56 having latch pins 58 are installed about the receiver 50 and can be extended from a retracted position to an extended position inside the receiver bore 52 of the receiver 50. The receiver bore 52 can also include one or more internal shoulders 53.

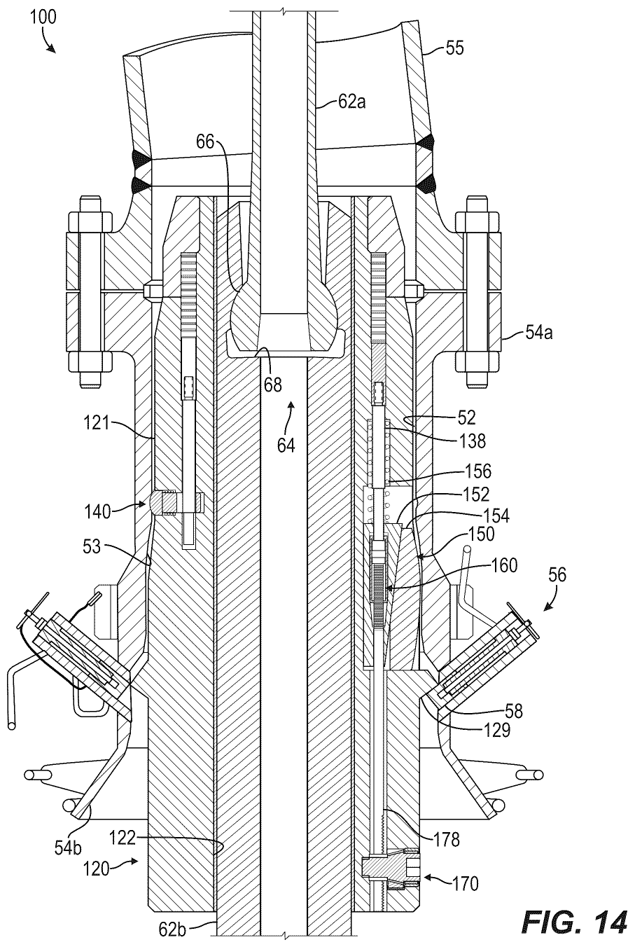

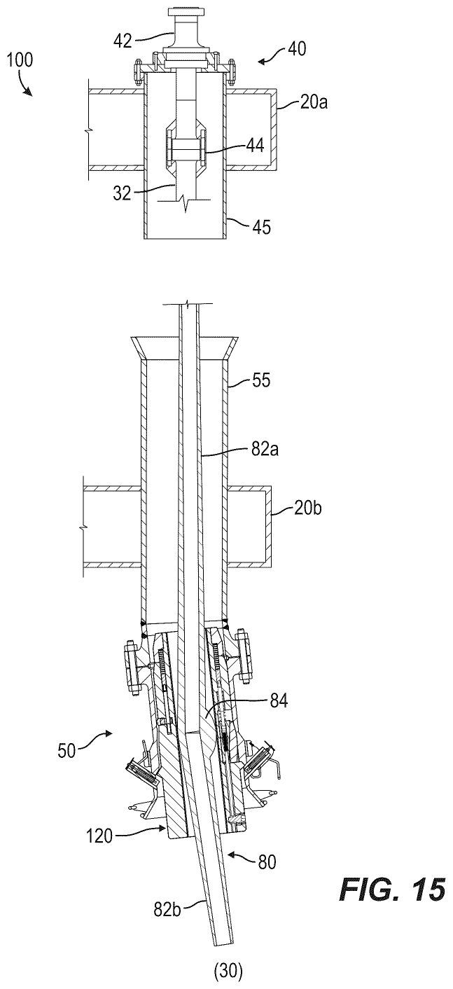

FIG. 14 illustrates a detailed cross-sectional view of the connector 120 mounted in the lower receiver 50 for the support system 100 of FIGS. 11 and 12. Features of the connector 120 can be similar to those disclosed previously so like reference numerals are used for comparable components. In particular, the connector 120 has a connector body 121, which can be cylindrical as shown. The connector body 121 defines a connector bore 122 therethrough, which can be lined with an internal wear sleeve to protect any coatings or surfaces on the pipe support 60 disposed in the connector's bore 122. The connector body 121 can be an integrated component or may be comprised of several interconnected components for the purposes of assembly.

The connector 120 has a trigger 140, an anchor 150, and a lock 170. Each of these can be an assembly, a mechanism, or the like having one or more components. Moreover, each of these is similar to the previous arrangements.

As before, the trigger assembly 140 is operatively coupled to the anchor assembly 150 using a retention rod 138, which is used to hold an activation wedge 152 in an inactive position against the bias of the activation spring 156. Additionally, the lock assembly 170 is operatively coupled to the anchor assembly 150 using a lock rod 178, which can further move and lock the activation wedge 152 toward the active position beyond the bias force of the activation spring 156. As before, the connector 120 can include a plurality of the features for the trigger assembly 140, the anchor assembly 150, and the lock assembly 170 disposed about the circumference of the body of the connector 120.

As further shown, the present connector 120 can further include a slip assembly 160, which is used in connection with the trigger and anchor assemblies 140, 150. The slip assembly 160 can be similar that discussed previously and is used between the activation wedge 152 and the lock rod 178.

The connector body 121 includes a latching shoulder 129 disposed about its outer diameter to interface with the spring-loaded latch pins 58 in the receiver 50 to retain the connector 120 at the lower balcony (20b). As shown, the connector 120 does not include a latch assembly (e.g., 130) as used in other configurations disclosed herein, although the connector 120 can include a latch assembly (130) if the receiver bore 52 in the receiver 50 includes appropriate latch profiles.

The anchor assembly 150 includes an activation wedge 152 and an engagement wedge 154 to provide wedged rigidizing inside the receiver bore 52 of the receiver 50. The engagement wedge 154 includes a shoulder that can further engage with the receiver's shoulder 53 in the receiver bore 52. The trigger assembly 140 is positioned to engage the internal shoulder 53 in the receiver bore 52 of the receiver 50 so the rigidizing wedges 152, 154 can be activated at the appropriate time when the connector 120 is inserted into the receiver 50.

As noted above, this configuration of the connector 120 has the pipe support 60 having the stress joints 62a-b connected by the articulable coupling 64 (the ball swivel 66 and socket 68), which can include appropriate seals (not shown). In combination, the pipe support 60 and the connector 120 provides a way for a rigid steel riser (not shown) to communicate through the angled lower receiver 50 and the extended I-tube 55 of upper receiver 40. Without the swiveling feature of the articulable coupling 64, a steel riser would not be able to navigate the bend without imparting excessive bending stress on the riser between the lower and upper riser balconies 20a-b.

FIG. 15 illustrates a cross-sectional view of another configuration of the support system 100 of FIG. 11 at the upper and lower balconies 20a-b of the vessel. As noted above, the support system 100 includes the connector 120 installed into the lower receiver 50, which is supported at the lower balcony 20b of the vessel. The lower receiver 50 may be an existing component on the vessel and can be similar to a bend stiffener receptacle noted previously.

An I-tube 55 is mounted with a flange to the top of the lower receiver 50 and extends upward toward the upper receiver 40 at the upper balcony 20a. The upper receiver 40 includes a hang-off interface 42 and an I-tube 45. The hang-off interface 42 can include a riser split flange hang-off interface.

The connector 120 installed in the lower receiver 50 has a stress joint support 80 installed in the bore of the connector 120. The stress joint support 80 has an upper stress joint 82a and a lower stress joint 82b. A lower section of the rigid riser (30) extends in the water from lower stress joint 82b, which can be tapered. The stress joint support 80 also has a fixed articulation 84 between the stress joints 82a-b so the stress joint support 80 can accommodate the angle of the lower receiver 50. For example, the fixed articulation 84 can include a ball or bulged feature installed in in the connector 120 and having the stress joints 82a-b extending at relative orientation to one another.

The upper stress joint 82a extends toward the I-tube 55 so the communication of the rigid riser (30) can extend to the upper balcony 20a. At the upper balcony 20a, for example, an upper section 32 of the rigid riser (30), which can be connected to the upper stress joint 82a, connects with a connector 44 to the hang-off interface 42 inside the I-tube 45. (If the upper stress joint 82a is long enough, then an upper end of the upper stress joint 82a can connect with the connector 44 to the hang-off interface 42.) In this configuration, the support system 100 can support the weight of rigid riser (30) and can centralize the upper stress joint 82a inside the I-tube 45, minimizing movement between the ball feature of the fixed articulation 84.

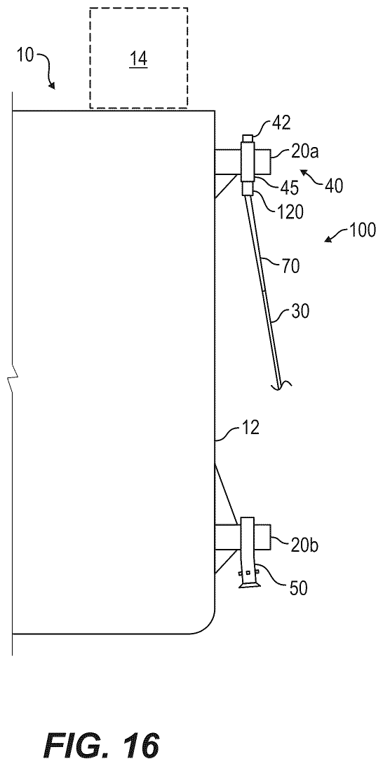

FIG. 16 illustrates an end view of a side 12 of a vessel 10 having upper and lowers balconies 20a-b. Another configuration of a support system 100 of the present disclosure supports a tubular component 30, such as a rigid riser, used for communicating between the vessel 10 and subsea components. Again, the vessel 10 can be a floating production storage and offloading (FPSO) unit or other type of structure and vessel. The balconies 20a-b of the vessel 10 include upper and lower receivers 40, 50 respectively, which may be designed to support a flexible riser and not the rigid riser 30. The support system 100 of the present disclosure includes a connector 120 and a stress joint 70. Even though the receivers 40, 50 may be designed for use with a flexible riser, the stress joint 70 and the connector 120 are used to support the rigid riser 30 without the need to modify the receivers 40, 50.

The lower receiver 50 may be supported on the lower balcony 20b, but it is not used in the current configuration. Instead, the support system 100 uses the upper receiver 40, which includes an I-tube 45 and a top interface spool or a hang-off interface 42.

During installation of the rigid riser 30, the equipment 14 on the vessel 10 can include a pull-in platform (not shown), which can be located above the upper balcony 20a and can be used to pull in the rigid riser 30 to the upper receiver 40 on the upper balcony 20a. Using a pull-in operation, for example, the rigid riser 30 can be pulled from the water to connect to the vessel 10 using the pull-in platform of the equipment 14. A pull-in wire can connect by a pull-in head to the connector 120, and the rigid riser 30 can be pulled to the upper receiver 40 on the upper balcony 20a.

The stress joint 70 is connected to the rigid riser 30. In turn, the stress joint 70 is connected to the connector 120. After the rigid riser 30 has been pulled to the upper receiver 40, the connector 120 enters the upper receiver 40. Upon entering, the connector 120 actuates inside the upper receiver 40. When actuated, for example, the connector 120 mechanically anchors inside the upper receiver 40. Meanwhile, a flanged connector on the connector 120 is connected to the hang-off interface 42 located on the upper receiver 40 at the deck of the vessel 10.

Once the connector 120 has been anchored, the connector 120 can be mechanically locked or rigidized in the upper receiver 40. For example, locking features on the connector 120 can be operated to lock or rigidize the connector 120 in the upper receiver 40.

As can be seen, the connector 120 fills the gap between a bore of the upper receiver 40 and an inner bore communicating with the rigid riser 30. The stress joint 70 is angled off to the end of the connector 120 so the rigid riser 30 can bypass the lower receiver 50. The stress joint 70 can be tapered and can be connected to the rigid riser 30 by a flanged or welded connection, for example.

The weight of the rigid riser 30 can be carried by the top termination at the hang-off interface 42 at the upper balcony 20a. Additionally, the connector 120 in the upper receiver 40 at the upper balcony 20a includes support features (e.g., wedges) that rigidize the connector 120 to the I-tube 45 and limit the bending forces transmitted to the hang-off interface 42, reducing the fatigue of the upper receiver 40.

The arrangement described above completes the traction support to secure the rigid riser 30 to the side of the vessel 10. Therefore, dynamic movements of the vessel 10 are not expected to cause relative movement between the rigid riser 30 and the support structures (balconies 20a-b, support system 100, etc.) used to secure the rigid riser 30 to the vessel 10. Meanwhile, the upper receiver 40, the stress joint 70, and the connector 120 provide lateral stabilization of the rigid riser 30, and the features on the connector 120 are mechanically actuated to provide a hang-off interface. Moreover, the mechanical actuation of the support system 100 rigidizes the connector 120 to the upper receiver 40 to improve fatigue performance of the system's components over the life of the installation.

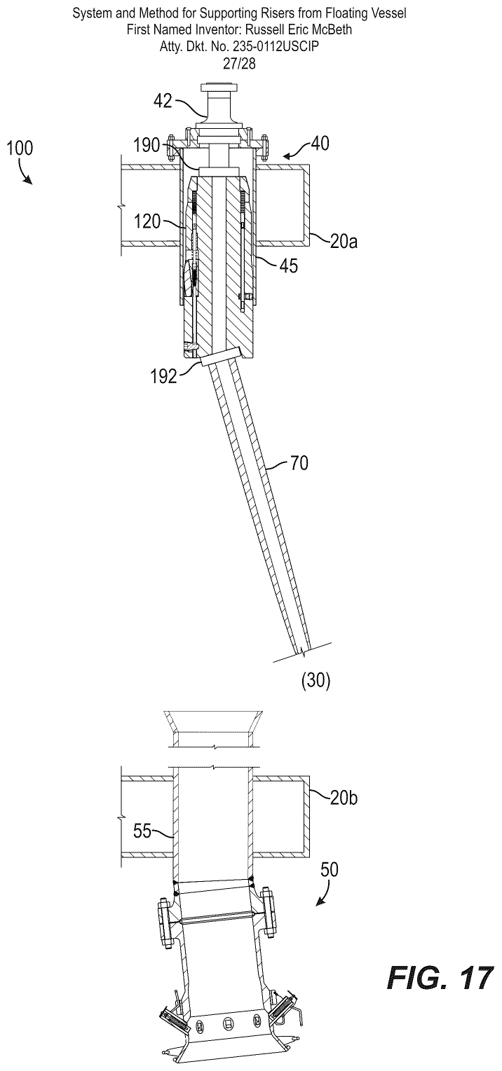

FIG. 17 illustrates a cross-sectional view of the support system 100 in FIG. 16. As noted above, the support system 100 includes the connector 120 installed into the upper receiver 40, which is supported at the upper balcony 20a of the vessel. The upper receiver 40 includes a hang-off interface 42 and an I-tube 45. The hang-off interface 42 can include a riser split flange hang-off interface.

Meanwhile, the lower receiver 50, which is not used, may be an existing component on the vessel and can be similar to a bend stiffener receptacle noted previously. An I-tube 55 mounted with a flange to the top of the lower receiver 50 may extend upward toward the upper receiver 40 at the upper balcony 20a.

In this configuration, the connector 120 provides the hang-off and rigidizing for the rigid riser (30) at the hang-off interface 42 of the upper balcony 20a. The connector 120 fits inside the I-tube 45 of the upper receiver 40, and a flange connection or interface 190 on the top of the connector 120 couples to the hang-off interface 42. The connector 120 can again include features similar to those disclosed previously. The connector 120 may not include the latch assembly (e.g., 130) but does include the trigger assembly (140) and the anchor assembly (150). The trigger assembly (140) is positioned to engage the I-tube 45 at the right time so as not to prematurely engage the rigidizing wedges of the anchor assembly (150).

The stress joint 70 is attached to the lower end of the connector 120 using a flange connection or flange interface 192. The stress joint 70 can be tapered, and the distal end of the stress joint 70 can be welded or flanged to the rigid riser (30). This configuration provides a way to hang off the riser (30) at the upper balcony 20a, while bypassing the lower receiver 50 on the lower balcony 20b. In particular, the flange interface 192 on the bottom end of the connector 120 can be angled to account for a required departure angle of the riser (30) to ensure the riser (30) does not interfere with the lower balcony 20b, the lower receiver 50, and adjacent risers. Moreover, the connector's wedging feature allows the connector 120 to be rigidized inside the I-tube 45 to transfer the riser's bending loads to the I-tube 45 and the upper balcony 20a. Without the rigidizing feature provided by the connector 120, a steel riser would impart excessive bending stress on the hang-off interface 42, causing fatigue and ultimate failure of the split-flange hang-off components.

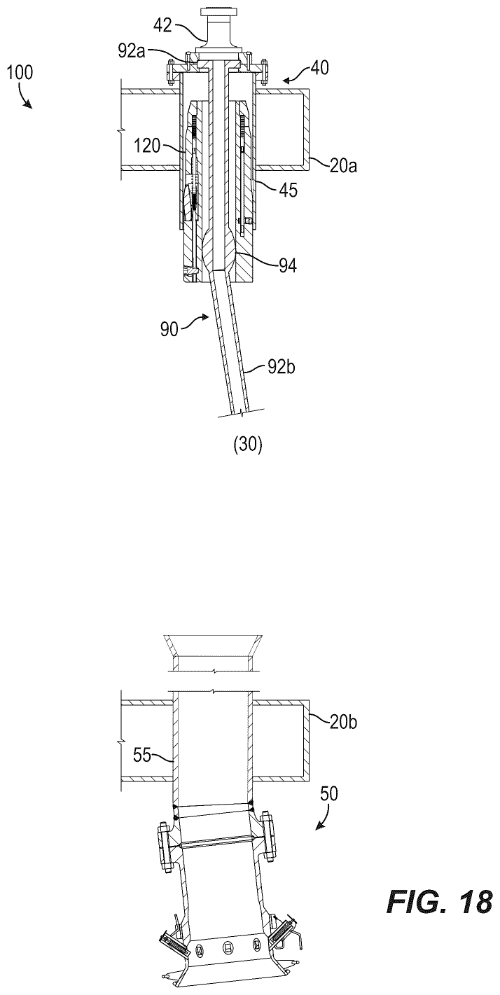

FIG. 18 illustrates a cross-sectional view of another configuration of the support system 100 of FIG. 16 at the upper and lower balconies 20a-b of the vessel. As noted above, the support system 100 includes the connector 120 installed into the upper receiver 40, which is supported at the upper balcony 20a of the vessel. The upper receiver 40 includes a hang-off interface 42 and an I-tube 45. The hang-off interface 42 can include a riser split flange hang-off interface.

Meanwhile, the lower receiver 50, which is not used, may be an existing component on the vessel and can be similar to a bend stiffener receptacle noted previously. An I-tube 55 mounted with a flange to the top of the lower receiver 50 may extend upward toward the upper receiver 40 at the upper balcony 20a.

In this configuration, the connector 120 provides the hang-off and rigidizing for the rigid riser (30) at the hang-off interface 42 of the upper balcony 20a. The connector 120 fits inside the I-tube 45 of the upper receiver 40. The connector 120 can again include features similar to those disclosed previously. The connector 120 may not include the latch assembly (e.g., 130) but does include the trigger assembly (140) and the anchor assembly (150). The trigger assembly (140) is positioned to engage the I-tube 45 at the right time so as not to prematurely engage the rigidizing wedges of the anchor assembly (150).

A stress joint support 90 is installed in the bore of the connector 120. The stress joint support 90 has a flange connection or an upper interface 92a and has a lower stress joint 92b. The upper interface 92a couples to the hang-off interface 42. The lower stress joint 92b can be tapered, and the distal end of the lower stress joint 92b can be welded or flanged to the rigid riser (30).

The stress joint support 90 also has a fixed articulation 94 between the upper interface 92a and the lower stress joint 92b so the stress joint support 90 can produce an angle in the upper receiver 40. For example, the fixed articulation 94 can include a ball or bulged feature installed in in the connector 120 and having the upper interface 92a and lower stress joints 92b extending at relative orientation to one another.

This configuration provides a way to hang off the riser (30) at the upper balcony 20a, while bypassing the lower receiver 50 on the lower balcony 20b. In particular, the fixed articulation 64 can be angled to account for a required departure angle of the riser (30) to ensure the riser (30) does not interfere with the lower balcony 20b, the lower receiver 50, and adjacent risers. The connector's wedging feature allows the connector 120 to be rigidized inside the I-tube 45 to transfer riser's bending loads to the I-tube 45 and the upper balcony 20a. Without the rigidizing feature provided by the connector 120, a steel riser would impart excessive bending stress on the hang-off interface 42, causing fatigue and ultimate failure of the split-flange hang-off components.

The foregoing description of preferred and other embodiments is not intended to limit or restrict the scope or applicability of the inventive concepts conceived of by the Applicants. It will be appreciated with the benefit of the present disclosure that features described above in accordance with any configuration or aspect of the disclosed subject matter can be utilized, either alone or in combination, with any other described feature, in any other configuration or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A system to support a tubular component used to communicate between a vessel and a subsea environment, the system comprising:
a connector disposed on the tubular component and being insertable in a receiver bore, the connector having:
a trigger disposed on the connector and being mechanically triggered in response to engagement with the receiver bore, the trigger being configured to initiate a first mechanical movement; and
an anchor disposed on the connector, the anchor being configured to mechanically engage against the receiver bore in response to the first mechanical movement.

2. The system of claim 1, wherein the connector further comprises a lock disposed on the connector, the lock being operatively coupled to the anchor and being mechanically movable with a second mechanical movement at least from an unlocked condition to a locked condition, the lock in the locked condition being configured to lock the anchor against the receiver bore.

3. The system of claim 2, wherein the connector further comprises a slip disposed on the connector between the lock and the anchor, the slip being configured to grip between the lock and the anchor in response to the lock being in the locked condition.

4. The system of claim 1, wherein the connector defines a side opening; and wherein the anchor comprises:
an activation wedge being axially moveable at least from an inactive position to an active position on the connector;
a biasing element biasing the activation wedge from the inactive position toward the active position; and
an engagement wedge disposed in the side opening of the connector and being laterally moveable from an unwedged position to a wedged position, the engagement wedge having the unwedged position in response to the activation wedge in the inactive position, the engagement wedge having the wedged position in response to the activation wedge in the active position, the engagement wedge in the wedged position being configured to engage against the receiver bore.

5. The system of claim 4, wherein the trigger comprises a retention rod being moveable axially from a first axial position to a second axial position, the retention rod in the first axial position holding the activation wedge in the inactive position, the retention rod in the second axial position releasing the activation wedge to move to the active position.

6. The system of claim 4, wherein the connector further comprises a lock disposed on the connector, the lock being operatively coupled to the anchor and being movable at least from an unlocked condition to a locked condition, the lock in the locked condition being configured to lock the activation wedge in the active position.

7. The system of claim 6, wherein the lock is movable from the locked condition to a released condition, the lock in the released condition being configured to move the activation wedge from the active position to the inactive position.

8. The system of claim 6, wherein the lock comprises:
a drive extending from the connector and being rotatable in a first direction;
a pinion gear being rotatable with the rotation of the drive in the first direction; and
a lock rod having a rack gear engaged with the pinion gear, the lock rod being axially moveable between an unlocked position and a locked position in response to movement of the rack gear by the rotation of the pinion gear in the first direction, the lock rod in the unlocked position permitting movement of the activation wedge from the activation position, the lock rod in the locked position preventing movement of the activation wedge from the activation position.

9-13. (canceled)

14. The system of claim 1, further comprising a support connected to the tubular component, the support having an upper stress joint, a coupling, and a lower stress joint, the upper stress joint connected to an upper portion of the tubular component, the lower stress joint connected to a lower portion of the tubular component, the lower stress joint disposed in the connector and extending from a lower end of the connector, the upper stress joint connected by the coupling to the lower stress joint and extending from an upper end of the connector, the coupling permitting the upper stress joint to articulate relative to the lower stress joint.

15. The system of claim 14, wherein the coupling comprises a ball on the upper stress joint disposed in a socket of the lower stress joint.

16. The system of claim 1, wherein the connector comprises a first flange interface connected to an upper end of the connector and being configured to connect to a hang-off interface on the vessel; and wherein the system comprises a stress joint being connected to the tubular component and being connected to a lower end of the connector.

17. The system of claim 16, wherein the connector comprises a second flange interface connecting the stress joint to the lower end of the connector.

18. The system of claim 1, further comprising a support connected to the tubular component, the support having an upper stress joint, a fixed articulation, and a lower stress joint, the fixed articulation disposed in the connector, the upper stress joint connected to the fixed articulation, extending from an upper end of the connector, and connected to an upper portion of the tubular component, the lower stress joint connected to the fixed articulation, extending from a lower end of the connector, and connected to a lower portion of the tubular component.

19. The system of claim 1, further comprising a receiver configured to be supported on the vessel, the receiver defining the receiver bore in which the connector is insertable.

20. The system of claim 19, wherein the receiver comprises a hang-off interface disposed in the receiver bore; wherein the connector comprises a first flange interface connected to an upper end of the connector and being configured to connect to the hang-off interface; and wherein the system comprises a stress joint being connected to the tubular component and being connected to a lower end of the connector.

21. The system of claim 20, wherein:
the receiver is an upper receiver;
the system further comprising a lower receiver configured to be supported on the vessel below the upper receiver; and
the connector comprises a second flange interface connecting the stress joint to the lower end of the connector, the second flange interface being defined at an angle, the angle being configured to direct the tubular component away from the lower receiver.

22. The system of claim 19, wherein the receiver comprises one or more pins movable between a retracted position and an extended position relative to the receiver bore; and wherein the connector defines a shoulder disposed on an exterior surface thereof, the shoulder being configured to engage against the one or more pins in the extended position.

23. The system of claim 19, wherein the receiver comprises a hang-off interface disposed in the receiver bore; and wherein the system comprises a support connected to the tubular component, the support having an upper interface, a fixed articulation, and a lower stress joint, the fixed articulation disposed in the connector, the upper interface connected to the fixed articulation, extending from an upper end of the connector, and connected to the hang-off interface, the lower stress joint connected to the fixed articulation, extending from a lower end of the connector, and connected to a lower portion of the tubular component.

24. The system of claim 19, wherein the receiver bore defines an engagement shoulder; and wherein the trigger is mechanically triggered in response to engagement with the engagement shoulder in the receiver bore.

25. The system of claim 19, wherein:
the receiver bore defines a latch profile therein;
the connector comprises a latch disposed on the connector, the trigger being operatively coupled to the latch; and
the latch is mechanically movable, in response to the first mechanical movement of the trigger, at least from a retracted condition to an extended condition on the connector, the latch in the extended condition being configured to latch in the latch profile in the receiver bore.

26-36. (canceled)

37. A vessel for which a tubular component is used to communicate between the vessel and a subsea environment, the vessel comprising:
a balcony extending from a side of the vessel; and
the system according to claim 1, the system having the receiver bore supported on the balcony of the vessel and having the connector disposed on the tubular component.

38. A system to support a tubular component used to communicate between a vessel and a subsea environment, the system comprising:
a receiver configured to be supported on the vessel, the receiver defining a receiver bore therethrough, the receiver having one or more pins movable between an extended position and a retracted position relative to the receiver bore;
a connector being insertable in the receiver bore, the connector having:
a trigger disposed on the connector and being mechanically triggered in response to engagement with the receiver bore, the trigger being configured to initiate a first mechanical movement; and
an anchor disposed on the connector, the anchor being configured to mechanically engage against the receiver bore in response to the first mechanical movement; and
a shoulder disposed on an exterior surface of the connector, the shoulder being configured to engage against the one or more pins in the extended position; and
a support connected to the tubular component, the support having an upper stress joint, a coupling, and a lower stress joint, the upper stress joint coupled to an upper portion of the tubular component, the lower stress joint coupled to a lower portion of the tubular component, the lower stress joint disposed in the connector and extending from a lower end of the connector, the upper stress joint connected by a coupling to the lower stress joint and extending from an upper end of the connector, the coupling permitting the upper stress joint to articulate relative to the lower stress joint.

39. The system of claim 38, wherein the coupling comprises a ball on the upper stress joint disposed in a socket of the lower stress joint.

40. A system to support a tubular component used to communicate between a vessel and a subsea environment, the system comprising:
a receiver configured to be supported on the vessel, the receiver defining a receiver bore and having a hang-off interface;
a connector being insertable in the receiver bore, the connector having:
a trigger disposed on the connector and being mechanically triggered in response to engagement with the receiver bore, the trigger being configured to initiate a first mechanical movement; and
an anchor disposed on the connector, the anchor being configured to mechanically engage against the receiver bore in response to the first mechanical movement; and
a flange interface connected to an upper end of the connector and being configured to connect to the hang-off interface; and
a stress joint being connected to the tubular component and being connected to a lower end of the connector.

41. A method used for a vessel, the method comprising:
inserting a connector disposed on a tubular component into a receiver bore of a receiver supported on the vessel;
mechanically triggering a trigger disposed on the connector in response to engagement of the trigger in the receiver bore;
mechanically releasing an anchor disposed on the connector in response to the mechanical triggering of the trigger; and
mechanically anchoring the anchor against the receiver bore in response to the mechanical release.

42-49. (canceled)
